(19) United States
(12) Patent Application Publication
(10) Pub. No.: US 2025/0212160 A1
(43) Pub. Date: Jun. 26, 2025

(54) METHODS, DEVICES, AND MEDIUM FOR COMMUNICATION

(71) Applicant: NEC Corporation, Tokyo (JP)

(72) Inventors: Wei CHEN, Beijing (CN); Peng GUAN, Beijing (CN); Gang WANG, Beijing (CN)

(73) Assignee: NEC Corporation, Tokyo (JP)

(21) Appl. No.: 18/876,857

(22) PCT Filed: Jun. 28, 2022
(86) PCT No.: PCT/CN2022/102045

§ 371 Date: Dec. 19, 2024

(51) Int. Cl. H04W 64/00; H04L 5/00; H04L 41/16

(52) U.S. Cl. CPC H04W 64/00; H04L 5/0048; H04L 41/16

(57) ABSTRACT

Example embodiments of the present disclosure relate to methods, devices, and medium for communication. A terminal device receives, from a core network device, an LPP message informing the terminal device to activate an AI-based positioning for determining location related information based on an output of the positioning model; and transmitting the location related information to the core network device. In additional, an interaction between an access network device and a core network device via NRPPa is triggered to activate an AI-based positioning for determining location related information based on the output of a positioning model, and transmitting the location related information to the core network device. In this way, a procedure between the terminal device and the core network device is defined and thus the positioning accuracy may be improved.

### FIELD

Example embodiments of the present disclosure generally relate to the field of communication techniques and in particular, to methods, devices, and a computer readable medium for communication.

### BACKGROUND

Several technologies have been proposed to improve communication performances. For example, communication devices may employ an artificial intelligent (AI)/machine learning (ML) model to improve communication qualities. The AI/ML model can be applied to different scenarios to achieve better performances.

A recent work item has been conducted in the third generation partner project (3GPP) for positioning support in new radio (NR) system. It is proposed to support AI/ML based positioning, and a positioning accuracy within 3GPP framework may be enhanced.

### SUMMARY

In general, example embodiments of the present disclosure provide methods, devices and a computer storage medium for communication. Embodiments that do not fall under the scope of the claims, if any, are to be interpreted as examples useful for understanding various embodiments of the disclosure.

In a first aspect, there is provided a method of communication. The method comprises: receiving, at a terminal device from a core network device, a long term evolution positioning protocol (LPP) message informing the terminal device to activate an AI-based positioning for determining location related information based on a positioning model; determining the location related information based on an output of the positioning model; and transmitting the location related information to the core network device.

In a second aspect, there is provided a method of communication. The method comprises: transmitting, at an access network device to a core network device, a first NR positioning protocol A (NRPPa) message requesting to activate an AI-based positioning; and receiving, from the core network device, a second NRPPa message informing the access network device whether to activate the AI-based positioning for determining location related information of a terminal device based on a positioning model.

In a third aspect, there is provided a method of communication. The method comprises: receiving, at a core network device from an access network device, a first NRPPa message requesting to activate an AI-based positioning; and transmitting, to the access network device, a second NRPPa message informing the access network device whether to activate the AI-based positioning for determining location related information of a terminal device based on a positioning model.

In a fourth aspect, there is provided a method of communication. The method comprises: transmitting, at a core network device to a terminal device, an LPP message informing the terminal device to activate an AI-based positioning for determining location related information based on a positioning model; and receiving, from the terminal device, location related information of the terminal device.

In a fifth aspect, there is provided a terminal device. The terminal device comprises a processor and a memory. The memory is coupled to the processor and stores instructions thereon. The instructions, when executed by the processor, cause the terminal device to perform the method according to the first aspect above.

In a sixth aspect, there is provided an access network device. The access network device comprises a processor and a memory. The memory is coupled to the processor and stores instructions thereon. The instructions, when executed by the processor, cause the access network device to perform the method according to the second aspect above.

In a seventh aspect, there is provided a core network device. The core network device comprises a processor and a memory. The memory is coupled to the processor and stores instructions thereon. The instructions, when executed by the processor, cause the core device to perform the method according to the third or the fourth aspect above.

In an eighth aspect, there is provided a computer readable medium having instructions stored thereon, the instructions, when executed on at least one processor, causing the at least one processor to carry out the method according to the first aspect, the second aspect, the third aspect or the fourth aspect above.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 illustrates a schematic diagram of an example system in which some embodiments of the present disclosure can be implemented;

FIG. 2A illustrates an exemplary architecture of a 5G system (5GS) capable of positioning a terminal device connected to an NG-RAN or an E-UTRAN in accordance with some embodiments of the present disclosure;

FIG. 2B illustrates an exemplary process for positioning a UE according to some embodiments of the present disclosure;

FIG. 2C illustrates exemplary protocol layers used to support LPP message transmission between an LMF and a UE according to some embodiments of the present disclosure;

FIG. 2D illustrates exemplary protocol layers used to support NRPPa PDU transmission between an LMF and an NG-RAN node according to some embodiments of the present disclosure;

FIG. 3A illustrates a schematic diagram illustrating an example process in which some embodiments of the present disclosure may be implemented;

FIG. 3B illustrates a schematic diagram illustrating an example process in which some embodiments of the present disclosure may be implemented;

FIGS. 4A-4D illustrate schematic diagrams of the AI-based positioning model in accordance with some embodiments of the present disclosure;

FIG. 5 illustrates a signalling chart illustrating process according to some example embodiments of the present disclosure;

FIGS. 6A-6B illustrate signalling charts illustrating process according to some example embodiments of the present disclosure;

FIG. 7 illustrates a signalling chart illustrating process according to some example embodiments of the present disclosure;

FIGS. 8A-8E illustrate signalling charts illustrating process according to some example embodiments of the present disclosure;

FIGS. 8F-8G illustrate signalling charts illustrating process according to some example embodiments of the present disclosure;

FIG. 9 illustrates a flowchart of an example method in accordance with some embodiments of the present disclosure;

FIG. 10 illustrates a flowchart of an example method in accordance with some embodiments of the present disclosure;

FIG. 11 illustrates a flowchart of an example method in accordance with some embodiments of the present disclosure;

FIG. 12 illustrates a flowchart of an example method in accordance with some embodiments of the present disclosure; and

FIG. 13 illustrates a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “terminal device” refers to any device having wireless or wired communication capabilities. Examples of terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also be incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

As used herein, the term “network device” refers to a device which is capable of providing or hosting a cell or coverage where terminal devices can communicate. Examples of a network device include, but not limited to, a satellite, a unmanned aerial systems (UAS) platform, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

Communications discussed herein may conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.85G, the third generation (3G), the fourth generation (4G), 4.5G, the fifth generation (5G), and the sixth (6G) communication protocols. The techniques described herein may be used for the wireless networks and radio technologies mentioned above as well as other wireless networks and radio technologies. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The terminal device or the network device may have Artificial intelligence (AI) or machine learning capability. It generally includes a model which has been trained from numerous collected data for a specific function, and can be used to predict some information.

The terminal device or the network device may work on several frequency ranges, e.g. FR1 (410 MHZ-7125 MHZ), FR2 (24.25 GHz to 71 GHZ), frequency band larger than 100 GHz as well as Tera Hertz (THz). It can further work on licensed/unlicensed/shared spectrum. The terminal device may have more than one connection with the network device under Multi-Radio Dual Connectivity (MR-DC) application scenario. The terminal device or the network device can work on full duplex, flexible duplex and cross division duplex modes.

The embodiments of the present disclosure may be performed in test equipment, e.g., signal generator, signal analyzer, spectrum analyzer, network analyzer, test terminal device, test network device, or channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

In the context of the present disclosure, the term “AI-based positioning” may be used interchangeably with AI/ML based positioning, ML based positioning, AI based positioning, AI/ML assistant positioning or the like. The term “positioning model” may be used interchangeably with AI positioning model, AI-based positioning model, AI-based model, AI/ML model, AI/ML positioning model, AI/ML based positioning model, or the like.

Supporting various positioning methods to provide a reliable and accurate location of a terminal device has always been a key feature of 3GPP standard. Further, in 5G-advanced, it has agreed to investigate the potential for AI/ML in air interface to achieve better performances. As one of use cased on release 18, it is worthy applying an AI/ML model into positioning of terminal devices, and the AI/ML based mechanism can be used to improve the positioning accuracy.

The current combination between AI/ML and positioning accuracy enhancement within 3GPP framework focuses on radio access technology (RAT)-dependent methods, which implement the positioning by a cooperation of a terminal device, an access network device and a core network device (such as a location and mobility function (LMF)), thus the AI model can be deployed at any of these sides. Further, the AI model training can be performed at one side and the AI model inference can be performed at other sides. For any of case, the sequence of procedure for supporting AI-based positioning should be defined in the RAN specification.

Embodiments of the present disclosure provide a solution of communication. In the solution, a terminal device may receive an LPP message from a core network device to activate an AI-based positioning. As such, the terminal device may determine its location related information based on an output of an AI-based positioning model. In this way, a procedure between the terminal device and the core network device is defined and thus the positioning accuracy may be improved.

Principles and implementations of the present disclosure will be described in detail below with reference to the figures.

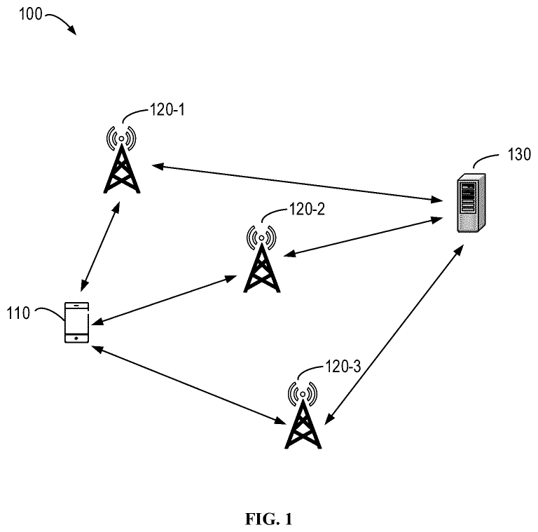

FIG. 1 illustrates a schematic diagram of an example system 100 in which some embodiments of the present disclosure can be implemented. The system 100, which is a part of a communication network, includes a terminal device 110. The system 100 further includes an access network device 120-1, an access network device 120-2 and an access network device 120-3, which can be collectively or respectively referred to as “access network device 120”. It is noted that only 3 access network devices are shown in FIG. 1, but the number of access network devices may be more than three, and the access network devices 120 in FIG. 1 are given for the purpose of illustration without suggesting any limitations. In some embodiments, the access network devices 120-1 to 120-3 may be implemented as multi-transmission and reception point (multi-TRP). In some embodiments, the access network devices 120-1 to 120-3 may be implemented as gNBs, for example, may include a serving gNB and neighboring gNBs.

The system 100 further includes a core network device 130, in some embodiments, the core network device 130 may comprise a location and mobility function (LMF). Additionally, the LMF may be referred to a location management function in some embodiments and will not be limited herein.

In the system 100, the access network device 120 can communicate/transmit data and control information to the terminal device 110, and the terminal device 110 can also communicate/transmit data and control information to the access network device 120. A link from the access network device 120 to the terminal device 110 is referred to as a downlink (DL), while a link from the terminal device 110 to the access network device 120 is referred to as an uplink (UL). DL may comprise one or more logical channels, including but not limited to a Physical Downlink Control Channel (PDCCH) and a Physical Downlink Shared Channel (PDSCH). UL may comprise one or more logical channels, including but not limited to a Physical Uplink Control Channel (PUCCH) and a Physical Uplink Shared Channel (PUSCH). As used herein, the term “channel” may refer to a carrier or a part of a carrier consisting of a contiguous set of resource blocks (RBs) on which a channel access procedure is performed in shared spectrum.

Communications in the system 100, between the access network device 120 and the terminal device 110 for example, may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

Embodiments of the present disclosure can be applied to any suitable scenarios. For example, embodiments of the present disclosure can be implemented at reduced capability NR devices. Alternatively, embodiments of the present disclosure can be implemented in one of the followings: NR multiple-input and multiple-output (MIMO), NR sidelink enhancements, NR systems with frequency above 52.6 GHz, an extending NR operation up to 71 GHZ, narrow band-Internet of Thing (NB-IoT)/enhanced Machine Type Communication (eMTC) over non-terrestrial networks (NTN), NTN, UE power saving enhancements, NR coverage enhancement, NB-IoT and LTE-MTC, Integrated Access and Backhaul (IAB), NR Multicast and Broadcast Services, or enhancements on Multi-Radio Dual-Connectivity.

It is to be understood that the numbers of devices (i.e., the terminal devices 110 and the access network device 120) and their connection relationships and types shown in FIG. 1 are only for the purpose of illustration without suggesting any limitation. The system 100 may include any suitable numbers of devices adapted for implementing embodiments of the present disclosure.

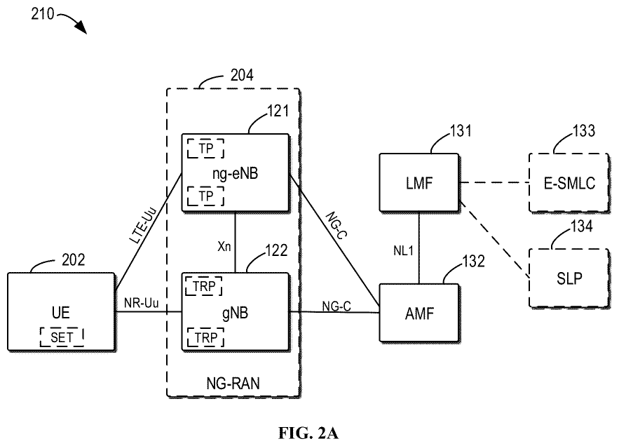

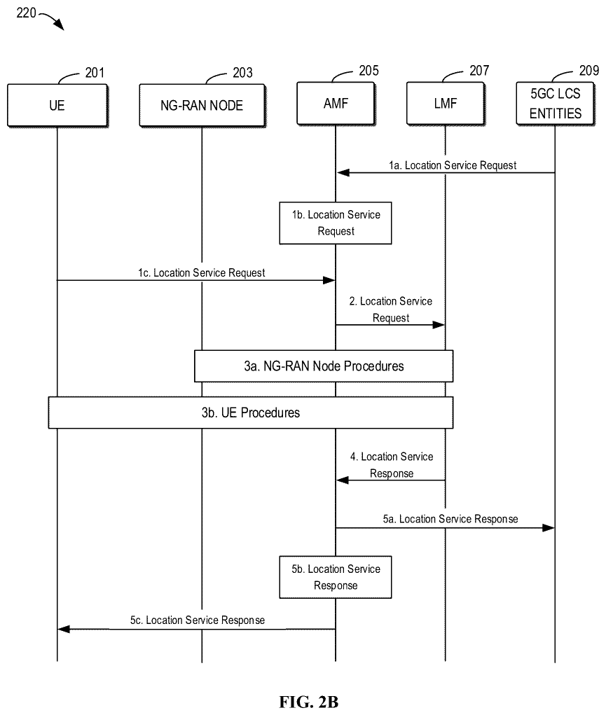

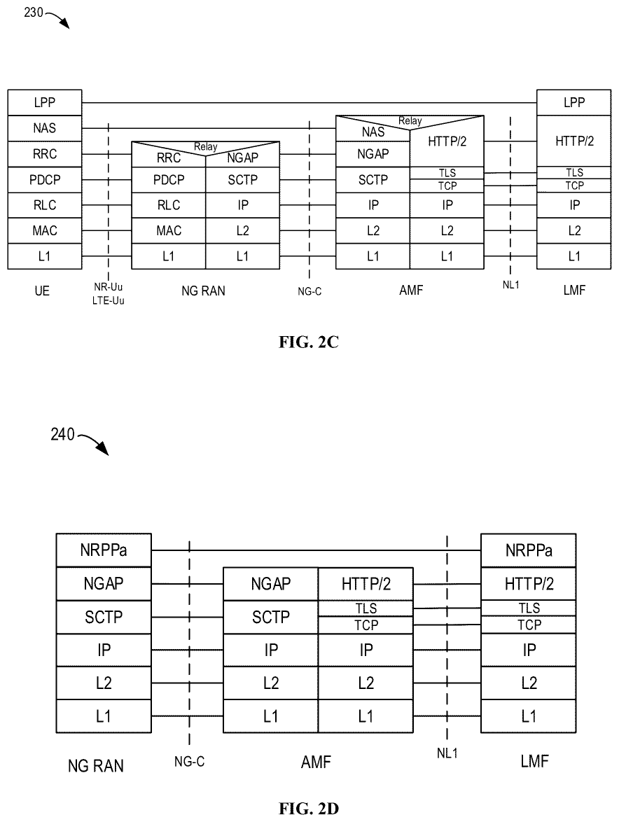

Reference is further made to FIG. 2A, which illustrates an exemplary architecture of a 5G system (5GS) 210 capable of positioning a terminal device connected to a next generation radio access network (NG-RAN) or an evolved UMTS terrestrial radio access network (E-UTRAN) according to some embodiments of the present disclosure.

As shown in FIG. 2A, a UE 202 may connect to an NG-RAN 204, which may include a new generation evolved-NB (ng-eNB) 121 and a gNB 122. The UE 202 may include a set, the ng-eNB 121 may include multiple transmission points (TPs), and the gNB 122 may include multiple TRPs.

An NR-Uu interface is used for connecting the UE 202 to the gNB 122 over the air, and is used as one of several transport links for the NR positioning protocol(s) for a target UE with NR access to NG-RAN 204. An LTE-Uu interface is used for connecting the UE 202 to the ng-eNB 121 over the air, and is used as one of several transport links for the LTE positioning protocol(s) for a target UE with LTE access to NG-RAN 204.

A NG-C interface is used for connecting the gNB 122 and a mobility management function (AMF) 132 or connecting the ng-eNB 121 and the AMF 132. The NG-C is transparent to all UE-positioning-related procedures. It is involved in these procedures only as a transport link for the NR positioning protocol(s). For gNB 122 related positioning procedures, the NG-C interface transparently transports both positioning requests from the LMF 131 to the gNB 122 and positioning results from the gNB 122 to the LMF 131. For ng-eNB 121 related positioning procedures, the NG-C interface transparently transports both positioning requests from the LMF 131 to the ng-eNB 121 and positioning results from the ng-eNB 121 to the LMF 131.

An NL1 interface is used for connecting the LMF 131 and the AMF 132, and is transparent to all UE related, gNB 122 related and ng-eNB 121 related positioning procedures. It is used only as a transport link for the LTE Positioning Protocols (LPP) and NR Positioning Protocol A (NRPPa).

The LMF 131 is connected to an enhanced serving mobile location center (E-SMLC) 133, and the E-SMLC 133 may enable the LMF 131 to access an E-UTRAN. The LMF 131 may be connected to a secure user plane location (SUPL) location platform (SLP) 134. The LMF 131 may support and manage different location determination services for target UEs.

It is proposed that the position information may be requested by and reported to a client (e.g., an application) associated with the UE 202, or by a client or attached to the core network.

FIG. 2B illustrates an exemplary process 220 for positioning a UE according to some embodiments of the present disclosure. The location service request may be implemented by step 1a, 1b or 1c.

In step 1a, 5th generation core network (5GC) location service (LCS) entities 209 (such as a gateway mobile location center (GMLC)) transmit a location service request for a target UE to the serving AMF 205. Alternatively, in step 1b, the serving AMF 205 for a target UE may determine the need for some location service, such as to locate to the UE 201 for an emergency call. Alternatively, in step 1c, the UE 201 requests some location service (e.g. positioning or delivery of assistance data) to the serving AMF 205 at a non-access stratum (NAS) level.

In step 2, the AMF 205 may transmit a location service request to an LMF 207. And the LMF 207 may start location procedures with the serving-eNB and the serving gNB to obtain positioning data or positioning assistance data in step 3a. Specifically, the LMF 207 instigates location procedures with the serving and possibly neighboring ng-eNB or gNB in the NG-RAN 203, e.g. to obtain positioning measurements or assistance data. In addition to step 3a or instead of step 3a, the LMF 207 may initiate a location procedure for DL positioning with the UE 201 in step 3b. Specifically, the LMF 207 instigates location procedures with the serving and possibly neighboring ng-eNB or gNB in the NG-RAN 203, e.g. to obtain positioning measurements or assistance data.

In step 4, the LMF 207 may provide a location service response to the AMF 205. The location service response may include any needed results, such as success or failure indication and, if requested and obtained, a location estimated for the UE 201.

Then, if step 1a was performed, the AMF 205 returns a location service response to the 5GC LCS entities 209 as shown in step 5a, and the location service response includes any needed results, e.g. a location estimate for the UE 201.

If step 1b occurred, the AMF 205 uses the location service response received in step 4 to assist the service that triggered this in step 1b (e.g., may provide a location estimate associated with an emergency call to a GMLC), as shown in step 5b.

If step 1c was performed, the AMF 205 returns a location service response to the UE 201 as shown in step 5c, and the location service response includes any needed results, e.g. a location estimate for the UE 201.

FIG. 2C illustrates exemplary protocol layers 230 used to support LTE positioning protocol (LPP) message transmission between an LMF and a UE according to some embodiments of the present disclosure.

A UE may include an L1 layer, a medium access control (MAC) layer, a radio link control (RLC) layer, a packet data convergence protocol (PDCP) layer, a radio resource control (RRC) layer, a non-access stratum (NAS) layer and an LPP layer. An NG-RAN node may include an L1 layer, an MAC layer, an RLC layer, a PDCP layer, an RRC layer, an internet protocol (IP) layer, a stream control transmission protocol (SCTP) layer, an NG application protocol (NGAP) layer and a relay. An AMF may include an L1 layer, an L2 layer, an IP layer, an SCTP layer, an NGAP layer, a NAS layer, a transmission control protocol (TCP) layer, a transport layer security (TLS) layer, a hypertext transport protocol (HTTP)/2 layer and a relay. An LMF may include an L1 layer, an L2 layer, an IP layer, a TCP layer, a TLS layer, an HTTP/2 layer and an LPP layer.

FIG. 2D illustrates exemplary protocol layers 240 used to support NR positioning protocol A (NRPPa) PDU transmission between an LMF and an NG-RAN node according to some embodiments of the present disclosure.

A NG-RAN node may include an L1 layer, an L2 layer, an IP layer, an SCTP layer, an NGAP layer and an NRPPa layer. An AMF may include an L1 layer, an L2 layer, an IP layer, an SCTP layer, an NGAP layer, a TCP layer, a TLS layer and an HTTP/2 layer. An LMF may include an L1 layer, an L2 layer, an IP layer, a TCP layer, a TLS layer, an HTTP/2 layer and an NRPPa layer.

In some embodiments, the positioning procedures for signalling protocols specified in TS 38.305 interface UE, gNB, AMF and LMF by NR-Uu, connecting the UE to the gNB over the air, LTE-Uu, connecting the UE to the ng-eNB over the air, NG-C, between the gNB and the AMF and between the ng-eNB and the AMF, and NL1, between the LMF and the AMF. The LPP protocol operates between UE and LMF. In some embodiments, the NRPPa protocol operates between gNB and LMF.

It is proposed to introduce an AI-based positioning method to enhance the positioning accuracy, accordingly the corresponding procedure should be specified to provide the signalling interface between UE and network. In some embodiments, for LPP protocol and NRPPa protocol, exchange of AI capabilities and trained AI model between UE, gNB and LMF are needed.

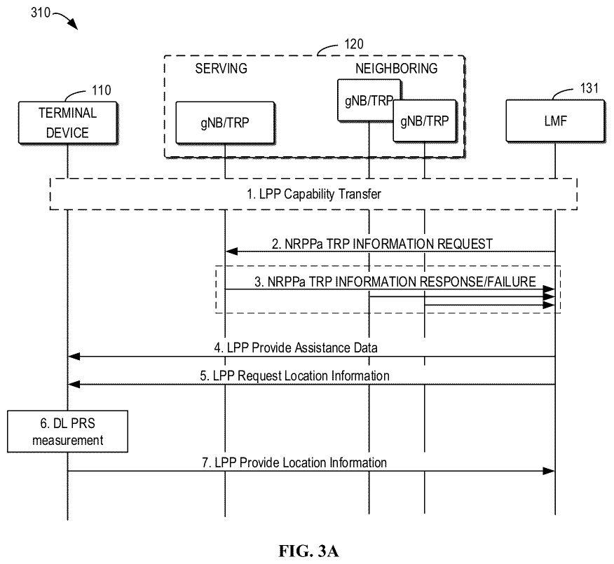

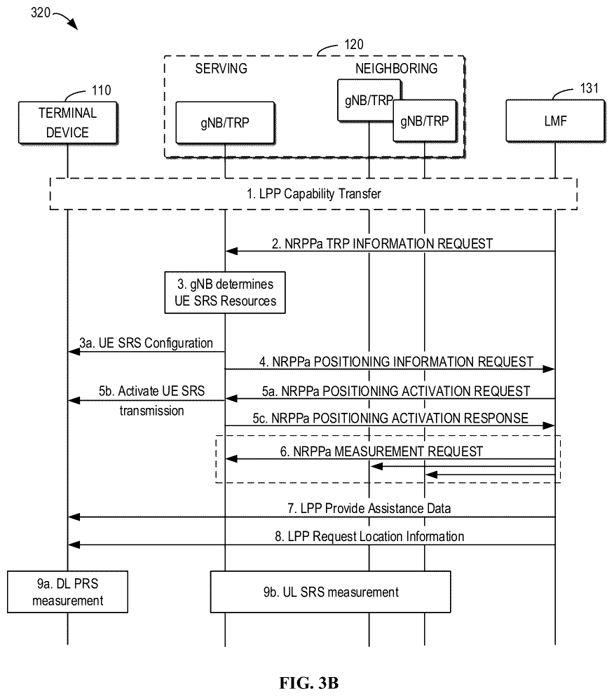

FIG. 3A illustrates a schematic diagram illustrating an example process 310 in which some embodiments of the present disclosure may be implemented. The process 310 involves a terminal device 110, an access network device 120 and an LMF131, where the access network device 120 may include a serving gNB/TRP and one or more neighboring gNBs/TRPs.

As shown in FIG. 3A, in step 1, the LMF 131 may request the positioning capabilities of the target terminal device 110 using the LPP Capability Transfer procedure. In step 2, the LMF 131 sends an NRPPa TRP INFORMATION REQUEST message to the gNB 120. This request includes an indication of which specific TRP configuration information is requested. In step 3, the gNB 120 provides the requested TRP information in an NRPPa TRP INFORMATION RESPONSE message if available at the gNB 120. In step 4, the LMF 131 determines that assistance data needs to be provided to the terminal device 110 and sends an LPP Provide Assistance Data message to the terminal device 110.

In step 5, the LMF 131 sends an LPP Request Location Information message to request reference signal time difference (RSTD) measurement. In step 6, the terminal device 110 performs the downlink-positioning reference signal (DL-PRS) measurements from all gNBs provided in the assistance data. In step 7, the terminal device 110 obtains a downlink-time difference of arrival (DL-TDOA) measurements as requested in step 5. The terminal device 110 then sends an LPP Provide Location Information message to the LMF 131.

FIG. 3B illustrates a schematic diagram illustrating an example process 320 in which some embodiments of the present disclosure may be implemented. The process 320 involves a terminal device 110, an access network device 120 and an LMF 131, where the access network device 120 may include a serving gNB/TRP and one or more neighboring gNBs/TRPs.

As shown in FIG. 3B, in step 1, the LMF 131 may request the positioning capabilities of the terminal device 110 using the LPP Capability Transfer procedure. In step 2, the LMF 131 sends an NRPPa TRP INFORMATION REQUEST message to the gNB 120. This request includes an indication of which specific TRP configuration information is requested. The serving gNB 120 determines the resources available for uplink-sounding reference signal (UL-SRS) in step 3 and configures the terminal device 110 with the UL-SRS resource sets in step 3a. In step 4, the serving gNB 120 provides the UL-SRS configuration information to the LMF 131.

For semi-persistent or aperiodic SRS, the LMF 131 may request activation of UE SRS transmission in step 5a, then the gNB 120 activates the UE SRS transmission in step 5b and sends an NRPPa Positioning Activation Response message to LMF 131 in step 5c. In step 6, the LMF 131 provides the UL information to the selected gNBs 120 in an NRPPa MEASUREMENT REQUEST. The message includes all information required to enable the gNBs/TRPs to perform the UL measurements.

In step 7, the LMF 131 sends a LPP Provide Assistance Data message to the terminal device 110. The message includes all information required to enable the gNBs/TRPs to perform the UL measurements. In step 8, the LMF 131 sends a LPP Request Location Information message to request multi round trip time (multi-RTT) measurements. In steps 9a and 9b, the terminal device 110 and each gNB 120 performs the DL-PRS measurements and UL SRS measurement.

It is understood that the processes in FIG. 3A-3B may be based on a non-AI based positioning, and in some cases, the determined location may not be accurate.

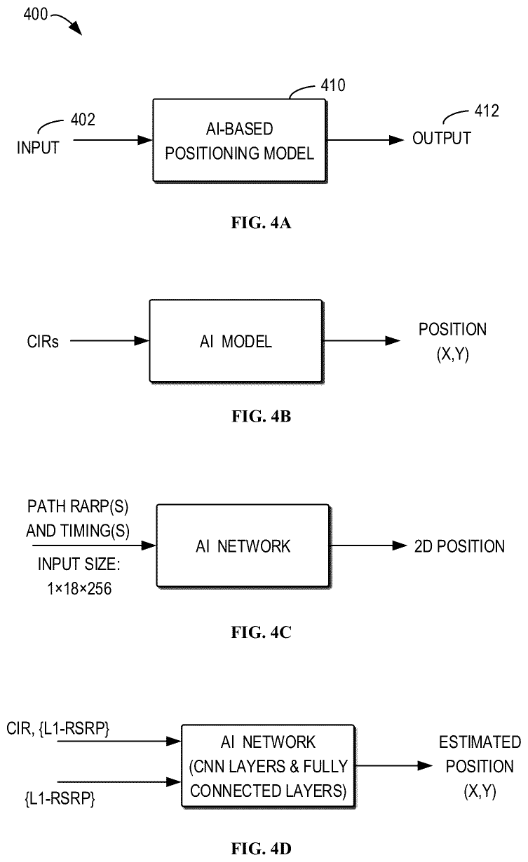

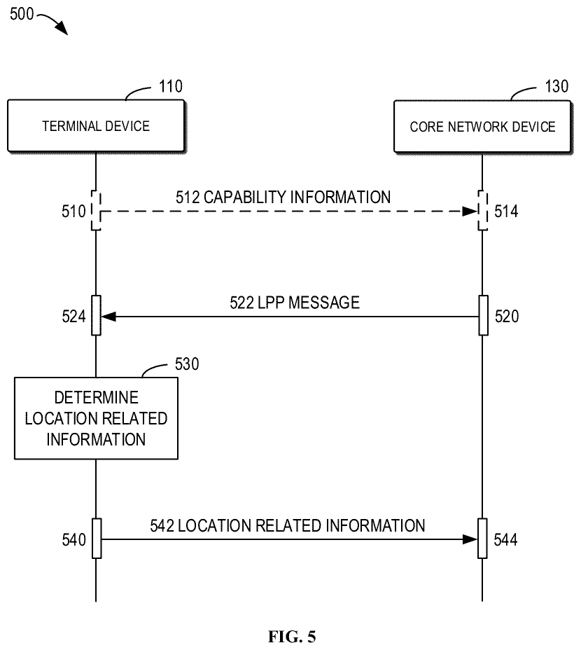

The present disclosure provides a solution of determining location related information of a terminal device based on an AI-based poisoning model. The model may be trained in a stage of model training, and may be used for determine the location related information in a stage of model inference. FIG. 4A illustrates a schematic diagram 400 of the AI-based positioning model in accordance with some embodiments of the present disclosure. As shown in FIG. 4A, an output 412 may be obtained based on an input 402 of the AI-based positioning mode 410.

In some embodiments, the input 402 may be based on positioning reference signals or may be based on other signals. In some example embodiments, the input 402 of the AI-based positioning mode 410 may include one or more of:
a time difference of arrival (TDOA) of different PRSs,
an angle of departure (AOD) of different PRSs,
a time difference of arrival (TDOA) of different SRSs,
an angle of arrival (AOA) of different SRSs,
a first measurement result, determined at a terminal device, indicating a receiving-transmitting (Rx-Tx) time difference between receiving a PRS from an access network device and transmitting a SRS to the access network device,
a second measurement result, determined at an access network device, indicating a Rx-Tx time difference between receiving a SRS from the terminal device and transmitting a PRS to the terminal device,
a channel impulse response (CIR) value obtaining from a channel state information-reference signal (CSI-RS),
a path reference signal received power (RSRP) from the CSI-RS or a synchronization signal block (SSB),
historical position information of the terminal device, or
a velocity of the terminal device.

In some embodiments, the output 412 may include location related information, such as, an RSTD, or an absolute location of the terminal device.

In some example embodiments, the AI-based positioning model 410 may be an AI model for short, the input 410 may be CIRs, and the output 412 may be a position of the terminal device, represented as (X, Y), as shown in FIG. 4B.

In some example embodiments, the AI-based positioning model 410 may be implemented as an AI network, the input 410 may be path RARP(s) and timing(s) with a size 1×18×256, and the output 412 may be a 2D position of the terminal device, as shown in FIG. 4C.

In some example embodiments, the AI-based positioning model 410 may be implemented as an AI network including convolutional neural network (CNN) layers and fully connected layers, the input 410 may be CIR and L1-RSRP or L1-RSRP, and the output 412 may be an estimated position of the terminal device, represented as (X, Y), as shown in FIG. 4D.

In some embodiments, the AI-based positioning model may be a one-side model, which is also called as a one-side AI/ML model. The one side model may be a UE-side (AI/ML) model or a network-side (AI/ML) model. In some examples, the UE-side (AI/ML) model may refer to an AI/ML model whose inference is performed entirely at the UE, and the network-side (AI/ML) model may refer to an AI/ML Model whose inference is performed entirely at the network.

In some embodiments, it is studied and provided some potential aspects on AI/ML approaches for sub use cases of AI/ML for positioning accuracy enhancement. In some examples, in a stage of AI/ML model training, it is proposed for training data type/size, training data source determination (e.g., UE/PRU/TRP), and assistance signalling and procedure for training data collection. In some examples, in a stage of AI/ML model indication/configuration, it is proposed for assistance signalling and procedure (e.g., for model configuration, model activation/deactivation, model recovery/termination, model selection). In some examples, in a stage of AI/ML model monitoring and update, it is proposed for assistance signalling and procedure (e.g., for model performance monitoring, model update/tuning).

In some examples, in a stage of AI/ML model inference input, it is proposed for report/feedback of model input for inference (e.g., UE feedback as input for network side model inference), model input acquisition and pre-processing, and type/definition of model input. In some examples, in a stage of AI/ML model inference output, it is proposed for report/feedback of model inference output, and post-processing of model inference output. In some examples, it is proposed for UE capability for AI/ML model(s) (e.g., for model training, model inference and model monitoring).

Embodiments of the present disclosure where the AI-based positioning is performed will be described in detail below. Reference is first made to FIG. 5, which illustrates a signalling chart illustrating process 500 according to some example embodiments of the present disclosure. Only for the purpose of discussion, the process 500 will be described with reference to FIG. 1. The process 500 may involve the terminal device 110 and the core network device 130 in FIG. 1. In some embodiments, the core network device 130 comprises an LMF.

The core network device 130 transmits 520 an LPP message 522 to the terminal device 110. In some embodiments, the LPP message 522 may include activation information informing the terminal device 110 to activate an AI-based positioning. In some embodiments, the LPP message 522 may be an LPP AI assistance positioning activation measurement to trigger the AI-based positioning.

In some example embodiments, the core network device 130 (such as the LMF) may trigger the AI-based positioning based on a change of channel environment, a heave non line of sight (NLOS) condition, or a synchronization error, and the present disclosure does not limit this aspect.

In some example embodiments, the LPP message 522 may include one or more of: a duration for activating the AI-based positioning, a type of an input of the positioning model, a report period of the output, an offset indicating a gap between ending a non-AI-based positioning and starting the AI-based positioning, a parameter for monitoring the positioning model, or a resource for collecting a dataset of the positioning model.

In some example embodiments, the LPP message 522 may include an information element (IE) “AIPositioningActication” and it may be implemented as:

| AIPositioingActivation ::= SEQUENCE { | |
|---|---|
| ... | |
| duration | Duration, |
| offset | {0, 1, 2, 4, ..., 63} |
| modelInput | ModelInput, |
| modelOutputReport | ModelOutputReport, |
| modelMointoring | ModelMointoring, |
| monitoringDataset | MonitoringDataset |

```
  ...
  }
```

In some example embodiments, the “duration” may be used to configure the duration of an active AI model. For example, how many times the AI model will be terminated; or how long to perform the AI based positioning. The time unit for the duration may be a symbol, a slot, a sub-frame, or a frame. In some example embodiments, the “offset” is used to configure a time gap between ending non-AI based positioning and starting AI-based positioning. For example, the time of ending non-AI based positioning may be a slot in which a last PRS is received, and the time of starting AI-based positioning may be a slot of beginning the AI-based positioning.

In some example embodiments, the “modelInput” may be used to configure the type of the input of the AI-based positioning model, for example, received PRS, RSRP, RSTD or CIR. In some example embodiments, the “modelOutputReport” may be used to configure a report of the output of the AI-based positioning model, for example, a report period or a report interval.

In some example embodiments, the “modelMonitoring” is used to configure a model monitoring parameter. For example, the parameter may include one of more of a monitoring frequency or a PRS resource for monitoring. In some example, the parameter may refer to an IE “modelMonitoring” in LPP and will not repeat herein. In some example embodiments, the “monitoringDataset” is used to configure the PRS resource to collect the dataset for monitoring the model.

On the other side of communication, the terminal device 110 receives 524 the LPP message 522. Accordingly, the terminal device 110 may download the positioning model from the network side. In some embodiments, an AI model configuration transfer procedure may be performed. In some example embodiments, the terminal device 110 may download a positioning model based on its capability information.

In some embodiments, the positioning model may be stored in an access network device, a core network device (such as an LMF), or other device, and the terminal device 110 may download the positioning model from a device which stores the positioning model. In some example embodiments, the downloaded positioning model may include AI model parameters, such as a type of network, layer, number of neurons per layer, etc.

Alternatively or in addition, the terminal device 110 transmits 510 capability information 512 to the core network device 130. On the other side of communication, the core network device 130 receives 514 the capability information 512 of the terminal device 110. In some embodiments, the transmission of the capability information 512 may be unsolicited.

In some embodiments, the transmission of the capability information 512 may be based on a request. In some examples, the core network device 130 may transmit a capability request for the capability information 512, and the terminal device 110 may transmit the capability information 512 to the core network device 130 based on the capability request.

In some example embodiments, the capability information 512 may indicate one or more of an expect positioning accuracy of the terminal device 110, a computing power of the terminal device 110, or a model size supported by the terminal device 110. In some examples, the computing power may be characterized by floating point operations per second (FLOPs).

In some example embodiments, the capability request may be carried in an LPP request capabilities message, the capability information 512 may be carried in an LPP provide capabilities message, and the present disclosure does not limit this aspect.

It is to be understood that the transmitting operation of the capability information 512 is shown before 520 in FIG. 5, however the present disclosure does not limit this aspect, for example, the terminal device 110 may transmit the capability information 512 after receiving the LPP message 522. In some examples, the capability information which is transmitted after the operation 524 may be carried in a dedicated capabilities message.

The terminal device 110 determines 530 location related information of the terminal device 110. Specifically, the terminal device 110 may determine the location related information based on an output of the downloaded positioning model. In some example embodiments, the terminal device 110 may perform model inference to determine (or obtain, predict) the location related information. In some examples, the location related information may indicate geographical coordinates of the terminal device 110. In some examples, the location related information may be an RTT value. In some examples, the location related information may be in standard formats, for example, configured by an access network device or a core network device.

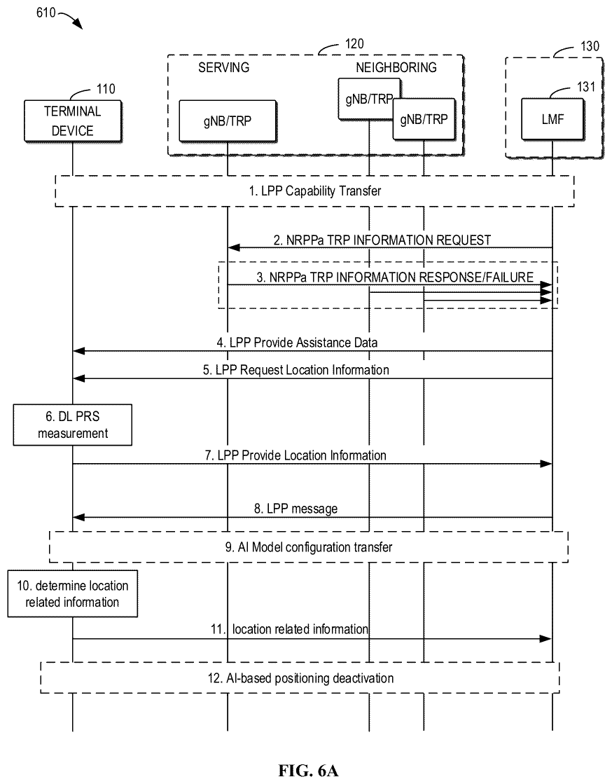

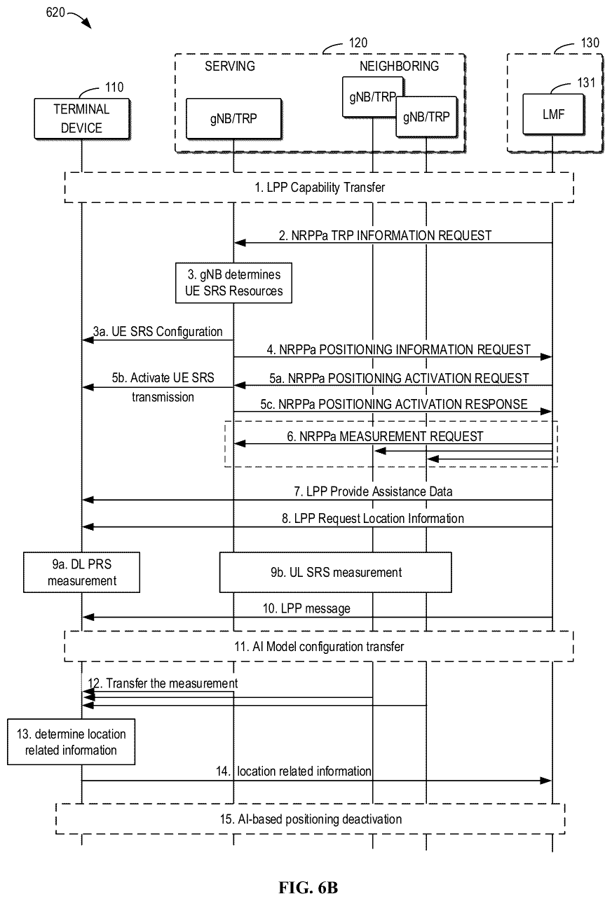

In some embodiments, the input of the positioning model may include a TDOA of different PRSs. Since the PRSs are transmitted from the access network device 120 to the terminal device 110, the TDOA of different PRSs may also be called as DL-TDOA. In some embodiments, the input of the positioning model may include an AOD of different PRSs, which may also be called as DL-AOD. In some example embodiments, a non-AI based positioning may be performed before the process 500, for example, the steps 1-7 in FIG. 3A may be performed before 520, or the steps 2-7 in FIG. 3A may be performed between 510 and 520, which will be described below with reference to FIG. 6A.

In some other embodiments, the input of the positioning model may include multi-RTT measurements, for example, a first measurement result and/or a second measurement result. The first measurement result may be obtained by the terminal device 110 and the second measurement result may be obtained by the access network device 120. For example, the access network device 120 may determine the second measurement result and transmit it to the terminal device 110. In some examples, the first measurement result may indicate an Rx-Tx time difference between receiving a PRS and transmitting as SRS at the terminal device 110. In some examples, the second measurement result may indicate an Rx-Tx time difference between receiving as SRS and transmitting a PRS at the access network device 120. In some example embodiments, a non-AI based positioning may be performed before the process 500, for example, the steps 1-9b in FIG. 3B may be performed before 520, or the steps 2-9b in FIG. 3B may be performed between 510 and 520, which will be described below with reference to FIG. 6B.

In some other embodiments, the input of the positioning model may include one or more of: a CIR value obtaining from a CSI-RS, a path RSRP from the CSI-RS or an SSB, historical position information of the terminal device 110, or a velocity of the terminal device 110. In this case, positioning reference signals (such as DL PRS or UL SRS) are not needed any more for the AI-based positioning model, and thus the communication efficiency may be improved. However, in some example embodiments, the terminal device 110 may still transmit UL SRS and/or receive DL PRS for collecting dataset during a stage of model monitoring, and the present disclosure does not limit this aspect.

The terminal device 110 transmits 540 the location related information 542 to the core network device 130. In some example embodiments, the location related information 542 may be transmitted through an LPP provide inference information including an output of the positioning model. As such, the terminal device 110 may report a result of AI model inference, and the result includes the location related information 542. In some example embodiments, the location related information may be used in or be used for assisting in computing a position of the terminal device 110. In some example embodiments, the location related information may be a location of the terminal device 110 directly. In some examples, the location related information may be an RTT value. In some example embodiments, the location related information may indicate an additional type, such as UE-like coordinates.

On the other side of communication, the core network device 130 (such as the LMF) receives 544 the location related information 542. As such, the core network device 130 may acquire the location related information 542 of the terminal device 110, where the AI model inference is performed at the terminal device 110.

Alternatively or in addition, the terminal device 110 may deactivate the AI-based positioning. In some example embodiment, the terminal device 110 may fall back to the non-AI based positioning or a normal positioning. In some embodiments, the deactivation information may also be called as an AI assistant positioning deactivation.

In some example embodiments, the terminal device 110 may receive deactivation information from the core network device 130, and then the terminal device 110 may deactivate the AI-based positioning. In some embodiments, the deactivation information may be transmitted via an NRPPa message AI positioning deactivation.

In some example embodiments, the terminal device 110 may receive deactivation information from the access network device 120, and then the terminal device 110 may deactivate the AI-based positioning. In some embodiments, the deactivation information may be transmitted via a DCI. In some embodiments, the deactivation information may also be transmitted from the access network device 120 to the core network device 130 via an LPP message AI positioning deactivation.

In some example embodiments, the terminal device 110 may make a decision by itself to deactivate the AI-based positioning, and then the terminal device 110 may deactivate the AI-based positioning. In some embodiments, the deactivation information may also be transmitted from the terminal device 110 to the core network device 130 via an LPP message AI positioning deactivation.

In this way, any of the terminal device 110, the access network device 120 or the core network device 130 may intend to terminate the AI-based positioning during a period of positioning model, the AI-based positioning may be deactivated and a non-AI based positioning may be recovered.

FIG. 6A illustrates a signaling chart illustrating process 610 according to some example embodiments of the present disclosure. Only for the purpose of discussion, the process 610 will be described with reference to FIG. 1. The process 610 may involve the terminal device 110, the access network device 120 and the core network device 130 in FIG. 1. In some embodiments, the access network device 120 may comprise a serving gNB/TRP and neighboring gNBs/TRPs. In some embodiments, the core network device 130 comprises an LMF 131.

In step 1, an LPP capability transfer procedure is performed. In some embodiments, the terminal device 110 transmits capability information to the core network device 130. In some embodiments, the core network device 130 transmits a capability request to the terminal device 110 and the terminal device 110 transmits the capability information based on the capability request. The following steps 2-7 may refer to shoes described with reference to FIG. 3A, and will not be repeated herein.

In step 8, the core network device 130 transmits an LPP message to the terminal device 110, which is similar to the LPP message 512 in FIG. 5. In step 9, an AI model configuration transfer is performed, specifically, the terminal device 110 may download the AI-based positioning model from a network side.

In step 10, the terminal device 110 determines location related information based on an output of the positioning model. In some embodiments, an input of the positioning model may include DL-TDOA and/or DL-AOD. In step 11, the terminal device 110 transmits the location related information to the core network device 130. The detailed description of the location related information may refer to operations 530 and 540 in FIG. 5.

In step 12, an AI-based positioning deactivation may be performed. Specifically, any of the terminal device 110, the access network device 120 or the core network device 130 may intend to terminate the AI-based positioning during a period of positioning model, the AI-based positioning may be deactivated and a non-AI based positioning may be recovered.

FIG. 6B illustrates a signaling chart illustrating process 620 according to some example embodiments of the present disclosure. Only for the purpose of discussion, the process 620 will be described with reference to FIG. 1. The process 620 may involve the terminal device 110, the access network device 120 and the core network device 130 in FIG. 1. In some embodiments, the access network device 120 may comprise a serving gNB/TRP and neighboring gNBs/TRPs. In some embodiments, the core network device 130 comprises an LMF 131.

The step 1 in FIG. 6B is similar to step 1 in FIG. 6A, the steps 2-9b in FIG. 6B may refer to steps 2-9b in FIG. 3B, and the steps 10-11 in FIG. 6B may refer to steps 8-9 in FIG. 6A, thus will not be repeated herein.

In Step 12, the access network device 120 transmits the measured results to the terminal device 110. In some embodiments, the access network device 120 may transfer the second measurement result to the terminal device 110, where the second measurement result indicates an Rx-Tx time difference between receiving as SRS and transmitting a PRS.

In step 13, the terminal device 110 determines location related information based on an output of the positioning model. In some embodiments, an input of the positioning model may include a first measurement result and a second measurement result. The steps 14-15 in FIG. 6B may refer to steps 11-12 in FIG. 6A respectively, thus will not be repeated herein.

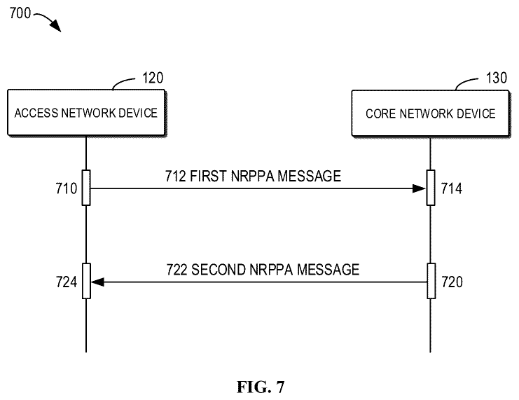

Reference is further made to FIG. 7, which illustrates a signaling chart illustrating process 700 according to some example embodiments of the present disclosure. Only for the purpose of discussion, the process 700 will be described with reference to FIG. 1. The process 700 may involve the access network device 120 and the core network device 130 in FIG. 1. In some embodiments, the access network device 120 may comprise a serving gNB. In some embodiments, the core network device 130 comprises an LMF.

The access network device 120 transmits 710 a first NRPPa message 712 to the core network device 130. In some example embodiments, the first NRPPa message 712 may be an NRPPa AI positioning request. In some example embodiments, the first NRPPa message 712 may be used for requesting an AI-based positioning. In some examples, the first NRPPa message 712 may request to activate the AI-based positioning.

In some example embodiments, the first NRPPa message 712 may include one or more of: a type of the positioning model, a type of the input of the positioning model, a type of the output of the positioning model, or a report period of the output.

On the other side of communication, the core network device 130 receives 714 the first NRPPa message 712. In some example embodiments, the core network device 130 may determine whether it can provide the requested information from the access network device 120 and may further generate a second NRPPa message, such as a successful or s failure message.

The core network device 130 transmits 720 a second NRPPa message 722 to the access network device 120. In some embodiments, the second NRPPa message 722 may be an AI positioning response indicating a successful response, or may be an AI positioning failure indicating a failed response.

In some example embodiments, the second NRPPa message 722 (for example, the AI positioning response) may include one or more of: an identity (ID) of the terminal device 110, a type of the positioning model, a type of the input of the positioning model, or a type of the output of the positioning model. For example, the second NRPPa message 722 may include the ID of the terminal device 110 since the channel environment is specific to each UE.

On the other side of communication, the access network device 120 receives 724 the second NRPPa message 722. In some examples, the process 700 may be called as an AI model exchange procedure, and the procedure is initiated by the access network device 120.

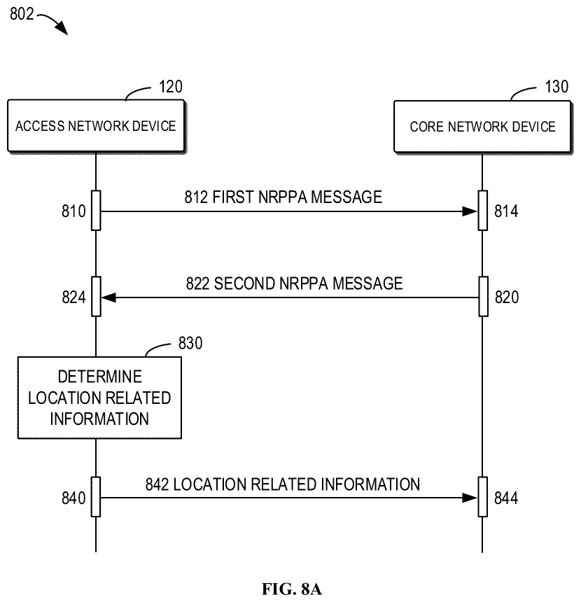

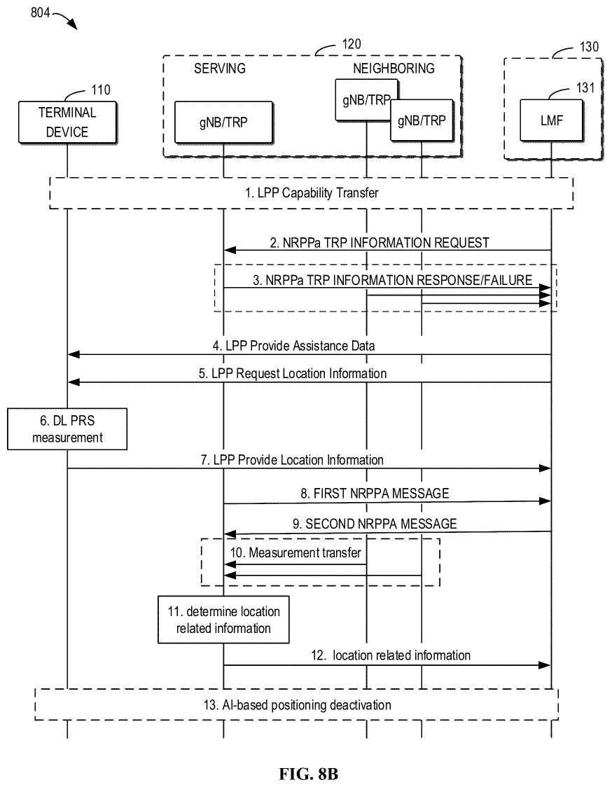

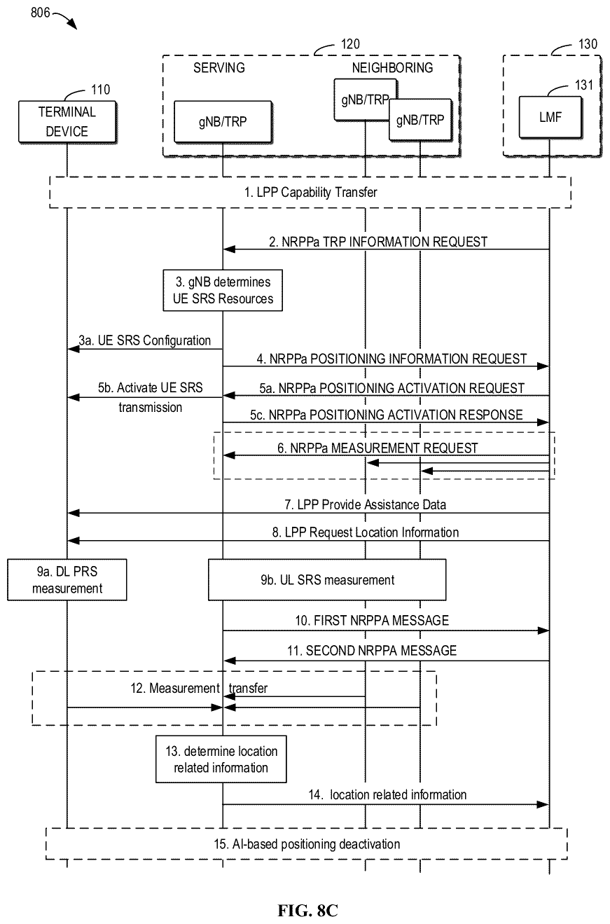

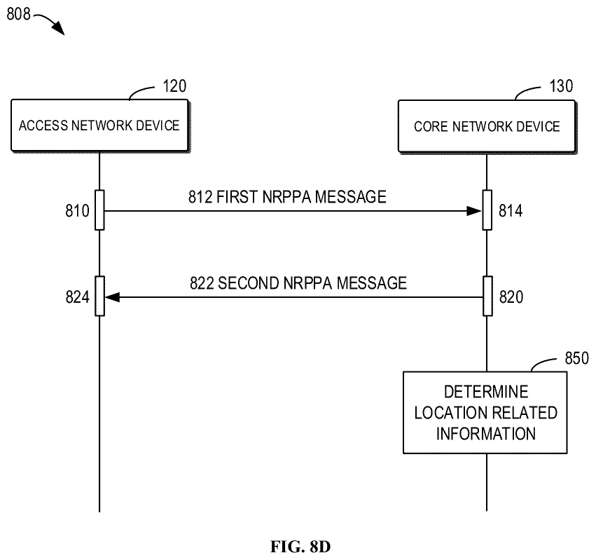

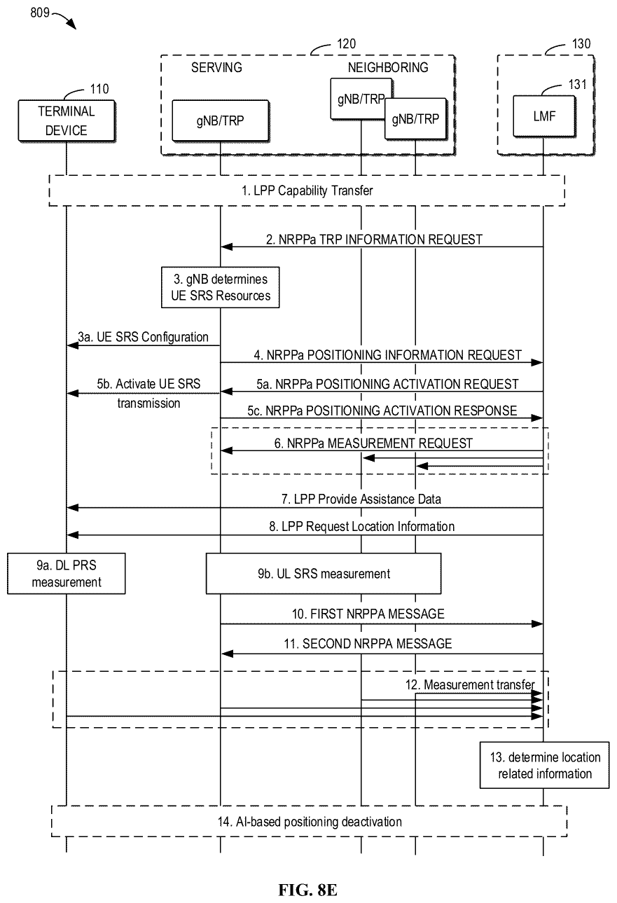

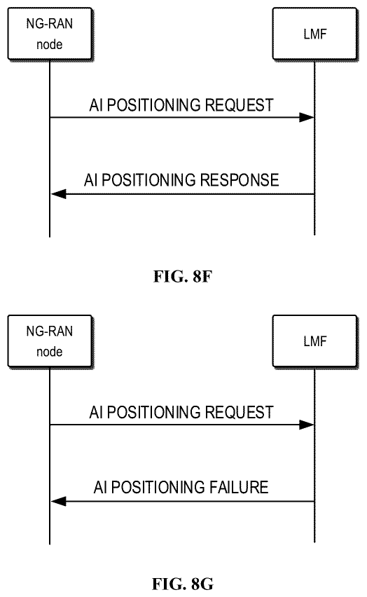

As such, the access network device 120 (such as a serving gNB) is allowed to request the core network device 130 (such as an LMF) to provide detailed information of the positioning model which is hosted by other stored node. In some embodiments, the positioning model inference may be further performed at the access network device 120 or the core network device 130, which are illustrated in FIGS. 8A-8E respectively.

FIG. 8A illustrates a signaling chart illustrating process 802 according to some example embodiments of the present disclosure. The process 802 may involve the access network device 120 and the core network device 130 in FIG. 1. In some embodiments, the core network device 130 comprises an LMF.

The access network device 120 transmits 810 a first NRPPa message 812 to the core network device 130, accordingly the core network device 130 receives 814 the first NRPPa message 812. The core network device 130 transmits 820 a second NRPPa message 822 to the access network device 120, accordingly the access network device 120 receives 824 the second NRPPa message 822. For example, the second NRPPa message 822 may be an AI positioning response indicating a successful response. It is to be understood that the first NRPPa message 812 and the second NRPPa message 822 may refer to those described above with reference to FIG. 7, and will not be repeated herein.

The access network device 120 determine 830 location related information of the terminal device 110. Specifically, the access network device 120 may determine the location related information based on an output of the downloaded positioning model. In some example embodiments, the access network device 120 may perform model inference to determine (or obtain, predict) the location related information. In some examples, the location related information may indicate geographical coordinates of the terminal device 110. In some examples, the location related information may be an RTT value.

In some embodiments, the input of the positioning model may include a TDOA of different SRSs. Since the SRSs are transmitted from the terminal device 110 to the access network device 120, the TDOA of different SRSs may also be called as UL-TDOA. In some embodiments, the input of the positioning model may include an AOA of different SRSs, which may also be called as UL-AOA. In some embodiments, a serving network device may receive measurement results from neighboring network devices. In some example embodiments, a non-AI based positioning may be performed before the process 802, for example, the steps 1-7 in FIG. 3A may be performed before 810, in some embodiments, step 1 may be replaced by a similar step described above at 510-514 in FIG. 5, which will be described below with reference to FIG. 8B.

In some other embodiments, the input of the positioning model may include multi-RTT measurements, for example, a first measurement result and/or a second measurement result. The first measurement result may be obtained by the terminal device 110 and the second measurement result may be obtained by the access network device 120. For example, the terminal device 110 may determine the first measurement result and transmit it to the access network device 120. In some examples, the first measurement result may indicate an Rx-Tx time difference between receiving a PRS and transmitting as SRS at the terminal device 110. In some examples, the second measurement result may indicate an Rx-Tx time difference between receiving as SRS and transmitting a PRS at the access network device 120. In some embodiments, a serving network device may receive measurement results from neighboring network devices. In some example embodiments, a non-AI based positioning may be performed before the process 802, for example, the steps 1-9b in FIG. 3B may be performed before 810, in some embodiments, step 1 may be replaced by a similar step described above at 510-514 in FIG. 5, which will be described below with reference to FIG. 8C.

In some other embodiments, the input of the positioning model may include one or more of: CSI from the terminal device 110, historical position information of the terminal device 110, or a velocity of the terminal device 110. In this case, positioning reference signals (such as DL PRS or UL SRS) are not needed any more for the AI-based positioning model, and thus the communication efficiency may be improved. However, in some example embodiments, the access network device 120 may still transmit DL PRS and/or receive UL SRS for collecting dataset during a stage of model monitoring, and the present disclosure does not limit this aspect.

The access network device 120 transmits 840 the location related information 842 to the core network device 130. In some example embodiments, the location related information 842 may be transmitted through an NRPPa AI inference report including an output of the positioning model. As such, the access network device 120 may report a result of AI model inference, and the result includes the location related information 842. In some example embodiments, the location related information may be used in or be used for assisting in computing a position of the terminal device 110. In some example embodiments, the location related information may be a location of the terminal device 110 directly. In some examples, the location related information may be an RTT value.

In some embodiments, the location related information may be transmitted by the access network device 120 in a periodical manner, in other words, the message may be a periodic report. In some embodiments, the indication of the report period may be included in the first NRPPa message 812.

On the other side of communication, the core network device 130 (such as the LMF) receives 844 the location related information 842. As such, the core network device 130 may acquire the location related information 842 of the terminal device 110, where the AI model inference is performed at the access network device 120.

Alternatively or in addition, the access network device 120 may deactivate the AI-based positioning. In some example embodiment, the access network device 120 may fall back to the non-AI based positioning or a normal positioning. In some embodiments, the deactivation information may also be called as an AI assistant positioning deactivation.

In some example embodiments, the access network device 120 may receive deactivation information from the core network device 130, and then the access network device 120 may deactivate the AI-based positioning. In some embodiments, the deactivation information may be transmitted via an LPP message AI positioning deactivation.

In some example embodiments, the access network device 120 may receive deactivation information from the terminal device 110, and then the access network device 120 may deactivate the AI-based positioning. In some embodiments, the deactivation information may also be transmitted from the terminal device 110 to the core network device 130 via an LPP message AI positioning deactivation.

In some example embodiments, the access network device 120 may make a decision by itself to deactivate the AI-based positioning, and then the access network device 120 may deactivate the AI-based positioning. In some embodiments, the deactivation information may also be transmitted from the access network device 120 to the core network device 130 via an LPP message AI positioning deactivation.

In this way, any of the terminal device 110, the access network device 120 or the core network device 130 may intend to terminate the AI-based positioning during a period of positioning model, the AI-based positioning may be deactivated and a non-AI based positioning may be recovered.

FIG. 8B illustrates a signaling chart illustrating process 804 according to some example embodiments of the present disclosure. The process 804 may involve the terminal device 110, the access network device 120 and the core network device 130 in FIG. 1. In some embodiments, the access network device 120 may comprise a serving gNB/TRP and neighboring gNBs/TRPs. In some embodiments, the core network device 130 comprises an LMF 131.

The steps 1-7 are similar to those shown in FIG. 6A, and the present disclosure will not repeat herein.

In step 8, the access network device 120 transmits a first NRPPa message to the core network device 130, and in step 9, the core network device 130 transmits a second NRPPa message to the access network device 120. The detailed description of the first and second NRPPa messages may refer to those described with reference to FIGS. 7-8A.

In step 10, the neighboring gNBs/TRPs may transfer measurement result to the serving gNB/TRP, where the measurement result may be an UL measurement on SRS(s).

In step 11, the access network device 120 determines location related information based on an output of the positioning model. In some embodiments, an input of the positioning model may include UL-TDOA and/or UL-AOA. In step 12, the access network device 120 transmits the location related information to the core network device 130. The detailed description of the location related information may refer to operations 830 and 840 in FIG. 8A.

In step 13, an AI-based positioning deactivation may be performed. Specifically, any of the terminal device 110, the access network device 120 or the core network device 130 may intend to terminate the AI-based positioning during a period of positioning model, the AI-based positioning may be deactivated and a non-AI based positioning may be recovered.

FIG. 8C illustrates a signaling chart illustrating process 806 according to some example embodiments of the present disclosure. The process 806 may involve the terminal device 110, the access network device 120 and the core network device 130 in FIG. 1. In some embodiments, the access network device 120 may comprise a serving gNB/TRP and neighboring gNBs/TRPs. In some embodiments, the core network device 130 comprises an LMF 131.

The steps 1-9b in FIG. 8C are similar to those shown in FIG. 3B, the steps 10-11 in FIG. 8C are similar to steps 8-9 in FIG. 8B respectively, and thus will not be repeated herein.

In step 12, the terminal device 110 and the neighboring gNBs/TRPs transmit the measurement results (such as, gNB Rx-Tx timing difference and UE Rx-Tx timing difference) to the serving gNB/TRP.

In step 13, the access network device 120 determines location related information based on an output of the positioning model and the access network device 120 transmits the location related information to the core network device 130 in step 14. The steps 13-14 may refer to the operations 830 and 840 in FIG. 8A.

In step 15, an AI-based positioning deactivation may be performed, which is similar to step 13 in FIG. 8B.

FIG. 8D illustrates a signaling chart illustrating process 808 according to some example embodiments of the present disclosure. The process 808 may involve the access network device 120 and the core network device 130 in FIG. 1. In some embodiments, the core network device 130 comprises an LMF.

The access network device 120 transmits 810 a first NRPPa message 812 to the core network device 130, accordingly the core network device 130 receives 814 the first NRPPa message 812. The core network device 130 transmits 820 a second NRPPa message 822 to the access network device 120, accordingly the access network device 120 receives 824 the second NRPPa message 822. For example, the second NRPPa message 822 may be an AI positioning response indicating a successful response. It is to be understood that the first NRPPa message 812 and the second NRPPa message 822 may refer to those described above with reference to FIG. 6, and will not be repeated herein.

The core network device 130 determines 850 location related information of the terminal device 110. Specifically, if the AI-based positioning is activated, the core network device 130 may determine the location related information based on an output of the downloaded positioning model. In some example embodiments, the core network device 130 may perform model inference to determine (or obtain, predict) the location related information. In some examples, the location related information may indicate geographical coordinates of the terminal device 110. In some examples, the location related information may be an RTT value.

In some other embodiments, the input of the positioning model may include multi-RTT measurements, for example, a first measurement result and/or a second measurement result. The first measurement result may be obtained by the terminal device 110 and the second measurement result may be obtained by the access network device 120. For example, the terminal device 110 may determine the first measurement result and transmit it to the core network device 130. For example, the access network device 120 (for example, including a serving gNB and neighboring gNBs) may determine the second measurement result and transmit it to the core network device 130. In some examples, the first measurement result may indicate an Rx-Tx time difference between receiving a PRS and transmitting as SRS at the terminal device 110. In some examples, the second measurement result may indicate an Rx-Tx time difference between receiving as SRS and transmitting a PRS at the access network device 120. In some example embodiments, a non-AI based positioning may be performed before the process 800, for example, the steps 1-9b in FIG. 3B may be performed before 810, which will be described below with reference to FIG. 8E.

In some other embodiments, the input of the positioning model may include one or more of: a CIR value obtaining from a CSI-RS, a path RSRP from the CSI-RS or an SSB, historical position information of the terminal device 110, or a velocity of the terminal device 110. In this case, positioning reference signals (such as DL PRS or UL SRS) are not needed any more for the AI-based positioning model, and thus the communication efficiency may be improved. In some example embodiments, the second NRPPa message 822 may include information indicating that mute or cancel the positioning RS (PRS and or SRS) configuration for the access network device 120 and/or the terminal device 110.

Alternatively or in addition, the core network device 130 may deactivate the AI-based positioning. In some example embodiment, the core network device 130 may fall back to the non-AI based positioning or a normal positioning. In some embodiments, the deactivation information may also be called as an AI assistant positioning deactivation.

In some example embodiments, the core network device 130 may receive deactivation information from the access network device 120, and then the core network device 130 may deactivate the AI-based positioning. In some embodiments, the deactivation information may be transmitted via an LPP message AI positioning deactivation.

In some example embodiments, the core network device 130 may receive deactivation information from the terminal device 110, and then the core network device 130 may deactivate the AI-based positioning. In some embodiments, the deactivation information may also be transmitted via an LPP message AI positioning deactivation.

In some example embodiments, the core network device 130 may make a decision by itself to deactivate the AI-based positioning, and then the core network device 130 may deactivate the AI-based positioning.

In this way, any of the terminal device 110, the access network device 120 or the core network device 130 may intend to terminate the AI-based positioning during a period of positioning model, the AI-based positioning may be deactivated and a non-AI based positioning may be recovered.

FIG. 8E illustrates a signaling chart illustrating process 809 according to some example embodiments of the present disclosure. The process 809 may involve the terminal device 110, the access network device 120 and the core network device 130 in FIG. 1. In some embodiments, the access network device 120 may comprise a serving gNB/TRP and neighboring gNBs/TRPs. In some embodiments, the core network device 130 comprises an LMF 131.

The steps 1-9b in FIG. 8E are similar to those shown in FIG. 3B, the steps 10-11 in FIG. 8E may refer to operations 810-824 in FIG. 8D, and thus will not be repeated herein.

In step 12, the terminal device 110 and the access network device 120 transmit the measurement results to the core network device 130. In some embodiments, the measurement results may include gNB Rx-Tx timing difference, UE Rx-Tx timing difference, or RSTD/RSRP. In some embodiments, the measurement results may include CIR and/or RSRP.

In step 13, the core network device 130 determines location related information based on an output of the positioning model. The step 13 may refer to the operation 850 in FIG. 8D. In step 14, an AI-based positioning deactivation may be performed. Specifically, any of the terminal device 110, the access network device 120 or the core network device 130 may intend to terminate the AI-based positioning during a period of positioning model, the AI-based positioning may be deactivated and a non-AI based positioning may be recovered.

The above various embodiments of the present disclosure may have partial impact to the current specification. For example, the current specification may be updated (underlined) as follows in view of the above various embodiments of the present disclosure.
Regarding Clause 8.10 in TS 38.305, section 8.10.2.1 may include information that may be transferred from the LMF to UE. The information that may be transferred from the LMF to the UE is listed in Table 8.10.2.1-1.

TABLE 8.10.2.1-1
Assistance data that may be transferred from LMF to the UE
Information

Physical cell IDs (PCIs), global cell IDs (GCIs), and PRS IDs,
ARFCNs of candidate NR TRPs for measurement
Timing relative to the serving (reference) TRP of candidate NR TRPs
DL-PRS configuration of candidate NR TRPs
SSB information of the TRPs (the time/frequency occupancy of SSBs)
PRS-only TP indication
On-Demand DL-PRS-Configurations
AI model duration, model input, model output report, model
monitoring, monitoring dataset
AI model deactivation indication

Regarding Clause 8.10 in TS 38.305, section 8.10.2.2 may include information that may be transferred from the UE to LMF. The information that may be signalled from UE to the LMF is listed in Table 8.10.2.2-1. The individual UE measurements are defined in TS 38.215.

TABLE 8.10.2.2-1
Measurement results that may be transferred from UE to the LMF
Information

PCI, GCI, and PRS ID, ARFCN, PRS resource ID, PRS resource
set ID for each measurement
DL-PRS-RSRP measurement
UE Rx-Tx time difference measurement
Time stamp of the measurement
Quality for each measurement
TA offset used by UE
UE Rx TEG IDs, UE Tx TEG IDs, and UE RxTx TEG IDs
associated with UE Rx-Tx time difference measurements
LOS/NLOS information for UE measurements
First path RSRP
Inference of the AI model

Regarding Clause 8.10 in TS 38.305, section 8.10.2.3 may include information that may be transferred from the gNB to LMF. The measurement results that may be signalled from gNBs to the LMF are listed in Table 8.10.2.3-3.

TABLE 8.10.2.3-3
Measurement results that may be transferred
from gNBs to the LMF
Measurement results

NCGI and TRP ID of the measurement
gNB Rx-Tx time difference measurement
UL-SRS-RSRP
UL Angle of Arrival (azimuth and elevation)
Time stamp of the measurement
Quality for each measurement
Beam Information of the measurement
Inference of the AI model

Regarding Clause 8.10 in TS 38.305, section 8.10.2.4 may include information that may be transferred from the LMF to gNBs. The TRP measurement request information that may be signalled from the LMF to the gNBs is listed in Table 8.10.2.4-2.

TABLE 8.10.2.4-2
TRP Measurement request information that may be
transferred from LMF to gNBs
Information

TRP ID, and NCGI of the TRP to receive UL-SRS
UE-SRS configuration
UL timing information together with timing uncertainty,
for reception of SRS by candidate TRPs
Report characteristics for the measurements
Measurement Quantities
Measurement periodicity
Measurement beam information request
RS quiet period for perform AI model inference

Regarding Clause 8.12 in TS 38.305, section 8.12.2 may include Information to be transferred between NG-RAN/5GC Elements, and section 8.12.2.3 may include information that may be transferred from the gNB to LMF. The assistance data that may be transferred from gNB to the LMF is listed in Table 8.12.2.3-1.

TABLE 8.12.2.3-1
Assistance data that may be transferred from gNB to the LMF
Information

PCI, GCI, ARFCN, and TRP IDs of the TRPs served by the gNB
Timing information of TRPs served by the gNB
DL-PRS configuration of the TRPs served by the gNB
SSB information of the TRPs (the time/frequency occupancy of SSBs)
Spatial direction information of the DL-PRS Resources of the
TRPs served by the gNB
Geographical coordinates information of the DL-PRS Resources
of the TRPs served by the gNB

The AI model related data that may be transferred from gNB to the LMF is listed in Table 8.12.2.3-2.

TABLE 8.12.2.3-2
AI model related data that may be
transferred from gNB to the LMF
Information

AI model type
model output
model input
gNB report period

Regarding Clause 8.2 in TS 38.455, a further section 8.2.12 may be included as below:

### 8.2.12 AI Model Information Exchange

### 8.2.12.1 General

The purpose of the AI Model Information Exchange procedure is to allow the NG-RAN node to request the LMF node to provide detailed information for AI model hosted by the LMF node. This procedure applies only if the NG-RAN node is a gNB.

### 8.2.12.2 Successful Operation

FIG. 8F may be referred as FIG. 8.2.12.2-1: AI Model Information Exchange procedure, successful operation
The NG-RAN node initiates the procedure by sending an AI POSITIONING REQUEST message. The LMF responds with an AI POSITIONING RESPONSE message that contains the requested AI model information.

### 8.2.12.3 Unsuccessful Operation

FIG. 8G may be referred as FIG. 8.2.12.2-2: AI Model Information Exchange procedure, unsuccessful operation
If the LMF cannot provide any of the requested information from the NG-RAN node, the LMF shall respond with a TRP INFORMARION FAILURE message.

According to the embodiments described with reference to FIG. 5 to FIG. 8E, the procedure between the terminal device and the core network device is defined and thus the positioning accuracy may be improved.

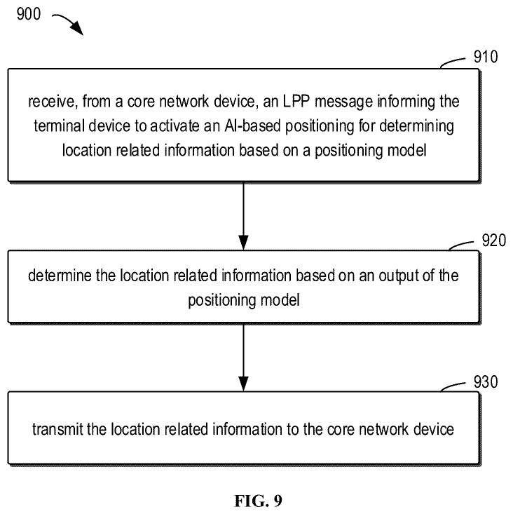

FIG. 9 illustrates a flowchart of an example method 900 implemented at a terminal device in accordance with some embodiments of the present disclosure. For the purpose of discussion, the method 900 will be described from the perspective of the terminal device 110 with reference to FIG. 1.

At block 910, the terminal device 110 receives, from a core network device 130, an LPP message informing the terminal device 110 to activate an AI-based positioning for determining location related information based on a positioning model. At block 920, the terminal device 110 determines the location related information based on an output of the positioning model. At block 930, the terminal device 110 transmits the location related information to the core network device 130.

In some example embodiments, an input of the positioning model comprises one or more of: a TDOA of different PRSs, an AOD of different PRSs, a first measurement result indicating a Rx-Tx time difference between receiving a PRS from an access network device and transmitting an SRS to the access network device 120, or a second measurement result, received from the access network device 120, indicating a Rx-Tx time difference between receiving a SRS from the terminal device 110 and transmitting a PRS to the terminal device 110.

In some example embodiments, an input of the positioning model comprises one or more of: a CIR value obtaining from a CSI-RS, a path RSRP from the CSI-RS or an SSB, historical position information of the terminal device 110, or a velocity of the terminal device 110.

In some example embodiments, the terminal device 110 deactivates the AI-based positioning based on one or more of: deactivation information, from the core network device 130, informing the terminal device 110 to deactivate the AI-based positioning; the deactivation information from an access network device 120, or a decision made by the terminal device 110 to deactivate the AI-based positioning.

In some example embodiments, the LPP message comprises one or more of: a duration for activating the AI-based positioning, a type of an input of the positioning model, a report period of the output, an offset indicating a gap between ending a non-AI-based positioning and starting the AI-based positioning, a parameter for monitoring the positioning model, or a resource for collecting a dataset of the positioning model.

In some example embodiments, the terminal device 110 transmits capability information of the terminal device 110 to the core network device 130.

In some example embodiments, if the terminal device 110 receives, from the core network device 130, a capability request for the capability information, then transmits the capability information to the core network device 130.

In some example embodiments, the capability information indicates one or more of: an expect positioning accuracy of the terminal device 110, a computing power of the terminal device 110, or a model size supported by the terminal device 110.

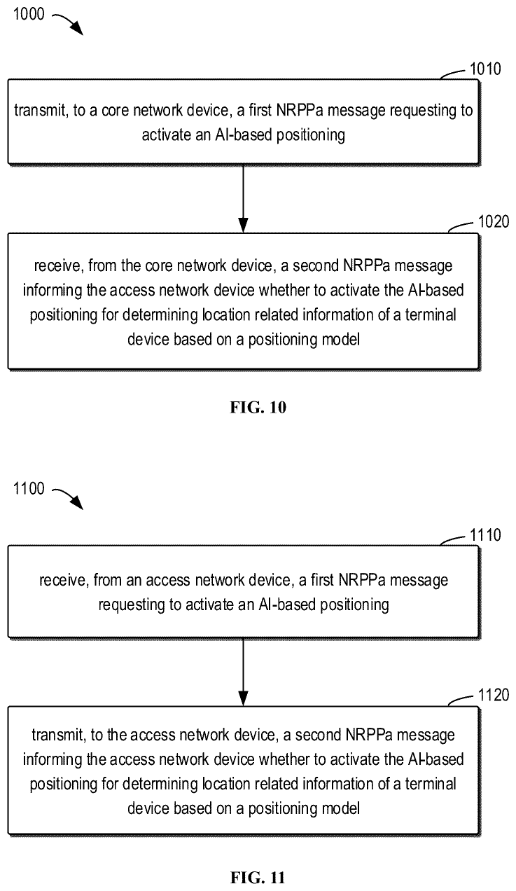

FIG. 10 illustrates a flowchart of an example method 1000 implemented at an access network device in accordance with some embodiments of the present disclosure. For the purpose of discussion, the method 1000 will be described from the perspective of the access network device 120 with reference to FIG. 1.

At block 1010, the access network device 120 transmits, to a core network device 130, a first NRPPa message requesting to activate an AI-based positioning. At block 1020, the access network device 120 receives, from the core network device 130, a second NRPPa message informing the access network device 120 whether to activate the AI-based positioning for determining location related information of a terminal device 110 based on a positioning model.

In some example embodiments, if the second NRPPa message informs the access network device 120 to activate the AI-based positioning, the access network device 120 determines the location related information of the terminal device 110 based on an output of the positioning model, and transmits the location related information to the core network device 130.

In some example embodiments, an input of the positioning model comprises one or more of: a TDOA of different SRSs, an AOA of different SRSs, a first measurement result, received from the terminal device 110, indicating a Rx-Tx time difference between receiving a PRS from the access network device 120 and transmitting a SRS to the access network device 120, or a second measurement result indicating a Rx-Tx time difference between receiving a SRS from the terminal device 110 and transmitting a PRS to the terminal device 110.

In some example embodiments, an input of the positioning model comprises one or more of: a CSI from the terminal device 110, historical position information of the terminal device 110, or a velocity of the terminal device 110.

In some example embodiments, the access network device 120 deactivates the AI-based positioning based on one or more of: deactivation information, from the core network device 130, informing the access network device 120 to deactivate the AI-based positioning; the deactivation information from the terminal device 110; or a decision made by the access network device 120 to deactivate the AI-based positioning.

In some example embodiments, the first NRPPa message comprises one or more of: a type of the positioning model, a type of an input of the positioning model, a type of the output, or a report period of the output.

In some example embodiments, the second NRPPa message comprises one or more of: an identity of the terminal device 110, a type of the positioning model, a type of an input of the positioning model, or a type of an output of the positioning model.

In some example embodiments, the second NRPPa message is a failure message.

FIG. 11 illustrates a flowchart of an example method 1100 implemented at a core network device in accordance with some embodiments of the present disclosure. For the purpose of discussion, the method 1100 will be described from the perspective of the core network device 130 with reference to FIG. 1.

At block 1110, the core network device 130 receives, from an access network device 120, a first NRPPa message requesting to activate an AI-based positioning. At block 1120, the core network device 130 transmits, to the access network device 120, a second NRPPa message informing the access network device 120 whether to activate the AI-based positioning for determining location related information of a terminal device 110 based on a positioning model.

In some example embodiments, if the AI-based positioning is activated, the core network device 130 determines the location related information based on an output of the positioning model.

In some example embodiments, an input of the positioning model comprises: a first measurement result, received from the terminal device 110, indicating a Rx-Tx time difference between receiving a PRS from the access network device and transmitting an SRS to the access network device 120, or a second measurement result, received from the access network device 120, indicating a Rx-Tx time difference between receiving a SRS from the terminal device 110 and transmitting a PRS to the terminal device 110.

In some example embodiments, an input of the positioning model comprises one or more of: a CIR value obtaining from a CSI-RS, a path RSRP from the CSI-RS or an SSB, historical position information of the terminal device 110, or a velocity of the terminal device 110.

In some example embodiments, the core network device 130 deactivates the AI-based positioning based on one or more of: deactivation information, from the access network device 120, informing the core network device 130 to deactivate the AI-based positioning; the deactivation information from the terminal device 110; or a decision made by the core network device 130 to deactivate the AI-based positioning.

In some example embodiments, the second NRPPa message is a failure message.

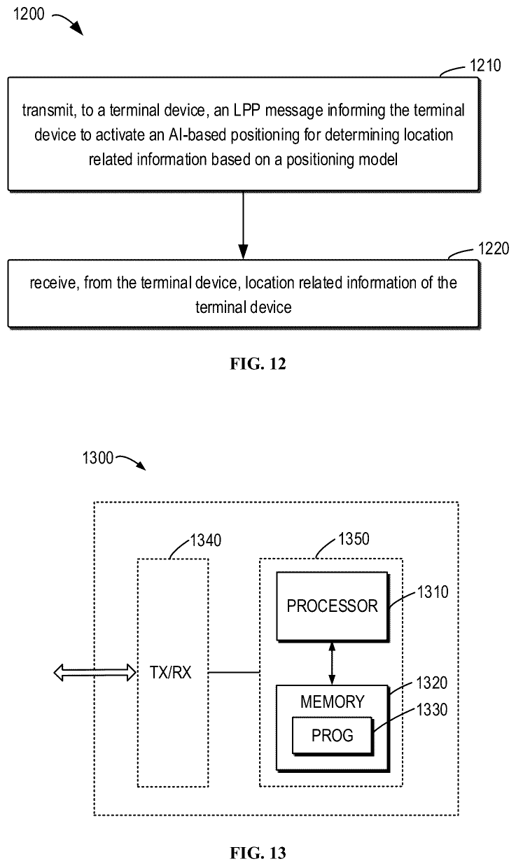

FIG. 12 illustrates a flowchart of an example method 1200 implemented at a core network device in accordance with some embodiments of the present disclosure. For the purpose of discussion, the method 2000 will be described from the perspective of the core network device 130 with reference to FIG. 1.

At block 1210, the core network device 130 transmits, to a terminal device 110, an LPP message informing the terminal device 110 to activate an AI-based positioning for determining location related information based on a positioning model. At block 1220, the core network device 130 receives, from the terminal device 110, location related information of the terminal device 110.

In some example embodiments, the LPP message comprises one or more of: a duration for activating the AI-based positioning, a type of an input of the positioning model, a report period of the output, an offset indicating a gap between ending a non-AI-based positioning and starting the AI-based positioning, a parameter for monitoring the positioning model, or a resource for collecting a dataset of the positioning model.

In some example embodiments, the core network device 130 transmits, to the terminal device 110, deactivation information informing the terminal device 110 to deactivate the AI-based positioning.

In some example embodiments, the core network device 130 receives capability information of the terminal device 110 from the terminal device 110.

In some example embodiments, the core network device 130 transmits, to the terminal device 110, a capability request for capability information of the terminal device 110; and receives the capability information from the terminal device 110.

In some example embodiments, the capability information indicates one or more of: an expect positioning accuracy of the terminal device 110, a computing power of the terminal device 110, or a model size supported by the terminal device 110.

Details of some embodiments according to the present disclosure have been described with reference to FIGS. 1-12. Now an example implementation of the devices will be discussed below.

In some example embodiments, a terminal device comprises circuitry configured to: receive, from a core network device, an LPP message informing the terminal device to activate an AI-based positioning for determining location related information based on a positioning model; determine the location related information based on an output of the positioning model; and transmit the location related information to the core network device. In some example embodiments, an input of the positioning model comprises one or

more of: a TDOA of different PRSs, an AOD of different PRSs, a first measurement result indicating a Rx-Tx time difference between receiving a PRS from an access network device and transmitting an SRS to the access network device, or a second measurement result, received from the access network device, indicating a Rx-Tx time difference between receiving a SRS from the terminal device and transmitting a PRS to the terminal device.

In some example embodiments, an input of the positioning model comprises one or more of: a CIR value obtaining from a CSI-RS, a path RSRP from the CSI-RS or an SSB, historical position information of the terminal device, or a velocity of the terminal device.

In some example embodiments, the terminal device comprises circuitry configured to: deactivate the AI-based positioning based on at least one of: deactivation information, from the core network device, informing the terminal device to deactivate the AI-based positioning, the deactivation information from an access network device, or a decision made by the terminal device to deactivate the AI-based positioning.

In some example embodiments, the LPP message comprises one or more of: a duration for activating the AI-based positioning, a type of an input of the positioning model, a report period of the output, an offset indicating a gap between ending a non-AI-based positioning and starting the AI-based positioning, a parameter for monitoring the positioning model, or a resource for collecting a dataset of the positioning model.

In some example embodiments, a terminal device comprises circuitry configured to: transmit capability information of the terminal device to the core network device.

In some example embodiments, a terminal device comprises circuitry configured to: in response to receiving, from the core network device, a capability request for the capability information, transmit the capability information to the core network device.

In some example embodiments, the capability information indicates one or more of: an expect positioning accuracy of the terminal device, a computing power of the terminal device, or a model size supported by the terminal device.

In some example embodiments, an access network device comprises circuitry configured to: transmit, to a core network device, a first NRPPa message requesting to activate an AI-based positioning; and receive, from the core network device, a second NRPPa message informing the access network device whether to activate the AI-based positioning for determining location related information of a terminal device based on a positioning model.

In some example embodiments, the access network device comprises circuitry configured to: in response to the second NRPPa message informing the access network device to activate the AI-based positioning, determine the location related information of the terminal device based on an output of the positioning model; and transmit the location related information to the core network device.

In some example embodiments, an input of the positioning model comprises one or more of: a TDOA of different SRSs, an AOA of different SRSs, a first measurement result, received from the terminal device, indicating a Rx-Tx time difference between receiving a PRS from the access network device and transmitting a SRS to the access network device, or a second measurement result indicating a Rx-Tx time difference between receiving a SRS from the terminal device and transmitting a PRS to the terminal device.

In some example embodiments, an input of the positioning model comprises one or more of: a CSI from the terminal device, historical position information of the terminal device, or a velocity of the terminal device.

In some example embodiments, an access network device comprises circuitry configured to: deactivate the AI-based positioning based on one or more of: deactivation information, from the core network device, informing the access network device to deactivate the AI-based positioning, the deactivation information from the terminal device, or a decision made by the access network device to deactivate the AI-based positioning.

In some example embodiments, the first NRPPa message comprises one or more of: a type of the positioning model, a type of an input of the positioning model, a type of the output, or a report period of the output.

In some example embodiments, the second NRPPa message comprises one or more of: an identity of the terminal device, a type of the positioning model, a type of an input of the positioning model, or a type of an output of the positioning model.

In some example embodiments, the second NRPPa message is a failure message.

In some example embodiments, a core network device comprises circuitry configured to: receive, from an access network device, a first NRPPa message requesting to activate an AI-based positioning; and transmit, to the access network device, a second NRPPa message informing the access network device whether to activate the AI-based positioning for determining location related information of a terminal device based on a positioning model.

In some example embodiments, the core network device comprises circuitry configured to: in accordance with a determination that the AI-based positioning is activated, determine the location related information based on an output of the positioning model.

In some example embodiments, an input of the positioning model comprises: a first measurement result, received from the terminal device, indicating a Rx-Tx time difference between receiving a PRS from the access network device and transmitting an SRS to the access network device, or a second measurement result, received from the access network device, indicating a Rx-Tx time difference between receiving a SRS from the terminal device and transmitting a PRS to the terminal device.

In some example embodiments, an input of the positioning model comprises one or more of: a CIR value obtaining from a CSI-RS, a path RSRP from the CSI-RS or an SSB, historical position information of the terminal device, or a velocity of the terminal device.

In some example embodiments, the core network device comprises circuitry configured to: deactivate the AI-based positioning based on one or more of: deactivation information, from the access network device, informing the core network device to deactivate the AI-based positioning, the deactivation information from the terminal device, or a decision made by the core network device to deactivate the AI-based positioning.

In some example embodiments, the second NRPPa message is a failure message.

In some example embodiments, a core network device comprises circuitry configured to: transmit, to a terminal device, an LPP message informing the terminal device to activate an AI-based positioning for determining location related information based on a positioning model; and receive, from the terminal device, location related information of the terminal device.

In some example embodiments, the LPP message comprises one or more of: a duration for activating the AI-based positioning, a type of an input of the positioning model, a report period of the output, an offset indicating a gap between ending a non-AI-based positioning and starting the AI-based positioning, a parameter for monitoring the positioning model, or a resource for collecting a dataset of the positioning model.

In some example embodiments, the core network device comprises circuitry configured to: transmit, to the terminal device, deactivation information informing the terminal device to deactivate the AI-based positioning.

In some example embodiments, the core network device comprises circuitry configured to: receive capability information of the terminal device from the terminal device.

In some example embodiments, the core network device comprises circuitry configured to: transmit, to the terminal device, a capability request for capability information of the terminal device; and receive the capability information from the terminal device.

In some example embodiments, the capability information indicates one or more of: an expect positioning accuracy of the terminal device, a computing power of the terminal device, or a model size supported by the terminal device.

FIG. 13 illustrates a simplified block diagram of a device 1300 that is suitable for implementing embodiments of the present disclosure. The device 1300 can be considered as a further example implementation of the terminal device 110, the access network device 120 and/or the core network device 130 as shown in FIG. 1. Accordingly, the device 1300 can be implemented at or as at least a part of the terminal device 110, the access network device 120 and/or the core network device 130.

As shown, the device 1300 includes a processor 1310, a memory 1320 coupled to the processor 1310, a suitable transmitter (TX) and receiver (RX) 1340 coupled to the processor 1310, and a communication interface coupled to the TX/RX 1340. The memory 1310 stores at least a part of a program 1330. The TX/RX 1340 is for bidirectional communications. The TX/RX 1340 has at least one antenna to facilitate communication, though in practice an Access Node mentioned in this disclosure may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1330 is assumed to include program instructions that, when executed by the associated processor 1310, enable the device 1300 to operate in accordance with the embodiments of the present disclosure, as discussed herein with reference to FIGS. 6-20. The embodiments herein may be implemented by computer software executable by the processor 1310 of the device 1300, or by hardware, or by a combination of software and hardware. The processor 1310 may be configured to implement various embodiments of the present disclosure. Furthermore, a combination of the processor 1310 and memory 1320 may form processing means 1350 adapted to implement various embodiments of the present disclosure.

The memory 1320 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1320 is shown in the device 1300, there may be several physically distinct memory modules in the device 1300. The processor 1310 may be of any type suitable to the local technical network, and may include one or more of general purpose computers, special purpose computers, microprocessors, digital signal processors (DSPs) and processors based on multicore processor architecture, as non-limiting examples. The device 1300 may have multiple processors, such as an application specific integrated circuit chip that is slaved in time to a clock which synchronizes the main processor.

In summary, embodiments of the present disclosure may provide the following solutions.

The present disclosure provides a method of communication, comprises: receiving, at a terminal device from a core network device, a long term evolution positioning protocol (LPP) message informing the terminal device to activate an artificial intelligence (AI)-based positioning for determining location related information based on a positioning model; determining the location related information based on an output of the positioning model; and transmitting the location related information to the core network device.

In one embodiment, the method as above, an input of the positioning model comprises at least one of: a time difference of arrival (TDOA) of different positioning reference signals (PRSs), an angle of departure (AOD) of different PRSs, a first measurement result indicating a receiving-transmitting (Rx-Tx) time difference between receiving a PRS from an access network device and transmitting a sounding reference signal (SRS) to the access network device, or a second measurement result, received from the access network device, indicating a Rx-Tx time difference between receiving a SRS from the terminal device and transmitting a PRS to the terminal device.

In one embodiment, the method as above, an input of the positioning model comprises at least one of: a channel impulse response (CIR) value obtaining from a channel state information-reference signal (CSI-RS), a path reference signal received power (RSRP) from the CSI-RS or a synchronization signal block (SSB), historical position information of the terminal device, or a velocity of the terminal device.

In one embodiment, the method as above, further comprises deactivating the AI-based positioning based on at least one of: deactivation information, from the core network device, informing the terminal device to deactivate the AI-based positioning, the deactivation information from an access network device, or a decision determined by the terminal device to deactivate the AI-based positioning.

In one embodiment, the method as above, the LPP message comprises at least one of: a duration for activating the AI-based positioning, a type of an input of the positioning model, a report period of the output, an offset indicating a gap between ending a non-AI-based positioning and starting the AI-based positioning, a parameter for monitoring the positioning model, or a resource for collecting a dataset of the positioning model.

In one embodiment, the method as above, further comprises: transmitting capability information of the terminal device to the core network device.

In one embodiment, the method as above, transmitting the capability information comprises: in response to receiving, from the core network device, a capability request for the capability information, transmitting the capability information to the core network device.

In one embodiment, the method as above, the capability information indicates at least one of: an expect positioning accuracy of the terminal device, a computing power of the terminal device, or a model size supported by the terminal device.

The present disclosure provides a method of communication, comprises: transmitting, at an access network device to a core network device, a first new radio positioning protocol A (NRPPa) message requesting to activate an artificial intelligence (AI)-based positioning; and receiving, from the core network device, a second NRPPa message informing the access network device whether to activate the AI-based positioning for determining location related information of a terminal device based on a positioning model.

In one embodiment, the method as above, further comprises: in response to the second NRPPa message informing the access network device to activate the AI-based positioning, determining the location related information of the terminal device based on an output of the positioning model; and transmitting the location related information to the core network device.

In one embodiment, the method as above, an input of the positioning model comprises at least one of: a time difference of arrival (TDOA) of different sounding reference signals (SRSs), an AOA of different SRSs, a first measurement result, received from the terminal device, indicating a receiving-transmitting (Rx-Tx) time difference between receiving a positioning reference signal (PRS) from the access network device and transmitting a SRS to the access network device, or a second measurement result indicating a Rx-Tx time difference between receiving a SRS from the terminal device and transmitting a PRS to the terminal device.

In one embodiment, the method as above, an input of the positioning model comprises at least one of: channel state information (CSI) from the terminal device, historical position information of the terminal device, or a velocity of the terminal device.

In one embodiment, the method as above, further comprises deactivating the AI-based positioning based on at least one of: deactivation information, from the core network device, informing the access network device to deactivate the AI-based positioning, the deactivation information from the terminal device, or a decision determined by the access network device to deactivate the AI-based positioning.

In one embodiment, the method as above, the first NRPPa message comprises at least one of: a type of the positioning model, a type of an input of the positioning model, a type of the output, or a report period of the output.

In one embodiment, the method as above, the second NRPPa message comprises at least one of: an identity of the terminal device, a type of the positioning model, a type of an input of the positioning model, or a type of an output of the positioning model.

In one embodiment, the method as above, the second NRPPa message is a failure message.

The present disclosure provides a method of communication, comprises: receiving, at a core network device from an access network device, a first new radio positioning protocol A (NRPPa) message requesting to activate an artificial intelligence (AI)-based positioning; and transmitting, to the access network device, a second NRPPa message informing the access network device whether to activate the AI-based positioning for determining location related information of a terminal device based on a positioning model.

In one embodiment, the method as above, further comprises: in accordance with a determination that the AI-based positioning is activated, determining the location related information based on an output of the positioning model.

In one embodiment, the method as above, an input of the positioning model comprises: a first measurement result, received from the terminal device, indicating a receiving-transmitting (Rx-Tx) time difference between receiving a positioning reference signal (PRS) from the access network device and transmitting a sounding reference signal (SRS) to the access network device, or a second measurement result, received from the access network device, indicating a Rx-Tx time difference between receiving a SRS from the terminal device and transmitting a PRS to the terminal device.

In one embodiment, the method as above, an input of the positioning model comprises at least one of: a channel impulse response (CIR) value obtaining from a channel state information-reference signal (CSI-RS), a path reference signal received power (RSRP) from the CSI-RS or a synchronization signal block (SSB), historical position information of the terminal device, or a velocity of the terminal device.

In one embodiment, the method as above, further comprises deactivating the AI-based positioning based on at least one of: deactivation information, from the access network device, informing the core network device to deactivate the AI-based positioning, the deactivation information from the terminal device, or a decision determined by the core network device to deactivate the AI-based positioning.

In one embodiment, the method as above, the second NRPPa message is a failure message.

The present disclosure provides a method of communication, comprises: transmitting, at a core network device to a terminal device, a long term evolution positioning protocol (LPP) message informing the terminal device to activate an artificial intelligence (AI)-based positioning for determining location related information based on a positioning model; and receiving, from the terminal device, location related information of the terminal device.

In one embodiment, the method as above, the LPP message comprises at least one of: a duration for activating the AI-based positioning, a type of an input of the positioning model, a report period of the output, an offset indicating a gap between ending a non-AI-based positioning and starting the AI-based positioning, a parameter for monitoring the positioning model, or a resource for collecting a dataset of the positioning model.

In one embodiment, the method as above, further comprises: transmitting, to the terminal device, deactivation information informing the terminal device to deactivate the AI-based positioning.

In one embodiment, the method as above, further comprises: receiving capability information of the terminal device from the terminal device.

In one embodiment, the method as above, further comprises: transmitting, to the terminal device, a capability request for capability information of the terminal device; and receiving the capability information from the terminal device.

In one embodiment, the method as above, the capability information indicates at least one of: an expect positioning accuracy of the terminal device, a computing power of the terminal device, or a model size supported by the terminal device.

The present disclosure provides a terminal device, comprising: a processor; and a memory storing computer program codes; the memory and the computer program codes configured to, with the processor, cause the terminal device to perform the method implemented at the terminal device discussed above.

The present disclosure provides an access network device, comprising: a processor; and a memory storing computer program codes; the memory and the computer program codes configured to, with the processor, cause the access network device to perform the method implemented at the access network device discussed above.

The present disclosure provides a core network device, comprising: a processor; and a memory storing computer program codes; the memory and the computer program codes configured to, with the processor, cause the core network device to perform the method implemented at the core network device discussed above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 5-13. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A method of communication, comprising:
receiving, at a terminal device from a core network device, a long term evolution positioning protocol (LPP) message informing the terminal device to activate an artificial intelligence (AI)-based positioning for determining location related information based on a positioning model;
determining the location related information based on an output of the positioning model; and
transmitting the location related information to the core network device.

2. The method of claim 1, wherein an input of the positioning model comprises at least one of:
a time difference of arrival (TDOA) of different positioning reference signals (PRSs),
an angle of departure (AOD) of different PRSs,
a first measurement result indicating a receiving-transmitting (Rx-Tx) time difference between receiving a PRS from an access network device and transmitting a sounding reference signal (SRS) to the access network device, or
a second measurement result, received from the access network device, indicating a Rx-Tx time difference between receiving a SRS from the terminal device and transmitting a PRS to the terminal device.

3. The method of claim 1, wherein an input of the positioning model comprises at least one of:
a channel impulse response (CIR) value obtaining from a channel state information-reference signal (CSI-RS),
a path reference signal received power (RSRP) from the CSI-RS or a synchronization signal block (SSB),
historical position information of the terminal device, or
a velocity of the terminal device.

4. The method of claim 1, further comprising deactivating the AI-based positioning based on at least one of:
deactivation information, from the core network device, informing the terminal device to deactivate the AI-based positioning,
the deactivation information from an access network device, or
a decision determined by the terminal device to deactivate the AI-based positioning.

5. The method of claim 1, wherein the LPP message comprises at least one of:
a duration for activating the AI-based positioning,
a type of an input of the positioning model,
a report period of the output,
an offset indicating a gap between ending a non-AI-based positioning and starting the AI-based positioning,
a parameter for monitoring the positioning model, or
a resource for collecting a dataset of the positioning model.

6. The method of claim 1, further comprising:
transmitting capability information of the terminal device to the core network device, wherein the capability information indicates at least one of:
an expect positioning accuracy of the terminal device,
a computing power of the terminal device, or
a model size supported by the terminal device.

7. A method of communication, comprising:
transmitting, at an access network device to a core network device, a first new radio positioning protocol A (NRPPa) message requesting to activate an artificial intelligence (AI)-based positioning; and
receiving, from the core network device, a second NRPPa message informing the access network device whether to activate the AI-based positioning for determining location related information of a terminal device based on a positioning model.

8. The method of claim 7, further comprising:
in response to the second NRPPa message informing the access network device to activate the AI-based positioning, determining the location related information of the terminal device based on an output of the positioning model; and
transmitting the location related information to the core network device.

9. The method of claim 8, wherein an input of the positioning model comprises at least one of:
a time difference of arrival (TDOA) of different sounding reference signals (SRSs),
an angle of arrival (AOA) of different SRSs,
a first measurement result, received from the terminal device, indicating a receiving-transmitting (Rx-Tx) time difference between receiving a positioning reference signal (PRS) from the access network device and transmitting a SRS to the access network device, or
a second measurement result indicating a Rx-Tx time difference between receiving a SRS from the terminal device and transmitting a PRS to the terminal device.

10. The method of claim 8, wherein an input of the positioning model comprises at least one of:
channel state information (CSI) from the terminal device,
historical position information of the terminal device, or
a velocity of the terminal device.

11. The method of claim 8, further comprising deactivating the AI-based positioning based on at least one of:
deactivation information, from the core network device, informing the access network device to deactivate the AI-based positioning,
the deactivation information from the terminal device, or
a decision determined by the access network device to deactivate the AI-based positioning.

12. The method of claim 7, wherein the first NRPPa message comprises at least one of:
a type of the positioning model,
a type of an input of the positioning model,
a type of the output, or
a report period of the output.

13. The method of claim 8, wherein the second NRPPa message comprises at least one of:
an identity of the terminal device,
a type of the positioning model,
a type of an input of the positioning model, or
a type of an output of the positioning model.

14. The method of claim 7, wherein the second NRPPa message is a failure message.

15. A method of communication, comprising:
receiving, at a core network device from an access network device, a first new radio positioning protocol A (NRPPa) message requesting to activate an artificial intelligence (AI)-based positioning; and
transmitting, to the access network device, a second NRPPa message informing the access network device whether to activate the AI-based positioning for determining location related information of a terminal device based on a positioning model.

16. The method of claim 15, further comprising:
in accordance with a determination that the AI-based positioning is activated, determining the location related information based on an output of the positioning model.

17. The method of claim 16, wherein an input of the positioning model comprises:
a first measurement result, received from the terminal device, indicating a receiving-transmitting (Rx-Tx) time difference between receiving a positioning reference signal (PRS) from the access network device and transmitting a sounding reference signal (SRS) to the access network device, or
a second measurement result, received from the access network device, indicating a Rx-Tx time difference between receiving a SRS from the terminal device and transmitting a PRS to the terminal device.

18. The method of claim 16, wherein an input of the positioning model comprises at least one of:
a channel impulse response (CIR) value obtaining from a channel state information-reference signal (CSI-RS),
a path reference signal received power (RSRP) from the CSI-RS or a synchronization signal block (SSB),
historical position information of the terminal device, or
a velocity of the terminal device.

19. The method of claim 16, further comprising deactivating the AI-based positioning based on at least one of:
deactivation information, from the access network device, informing the core network device to deactivate the AI-based positioning,
the deactivation information from the terminal device, or
a decision determined by the core network device to deactivate the AI-based positioning.

20. The method of claim 15, wherein the second NRPPa message is a failure message.
